(19) United States
(12) Patent Application Publication
(10) Pub. No.: US 2026/0329106 A1
(43) Pub. Date: Oct. 22, 2026

(54) LENS DRIVING DEVICE, CAMERA DEVICE, AND OPTICAL DEVICE

(71) Applicant: LG INNOTEK CO., LTD., Seoul (KR)

(72) Inventors: Yun Ho NOH, Seoul (KR); Sung Guk LEE, Seoul (KR)

(21) Appl. No.: 19/116,845

(22) PCT Filed: Jun. 26, 2023
(86) PCT No.: PCT/KR2023/008874

§ 371 Date: Mar. 28, 2025

(30) Foreign Application Priority Data
Sep. 28, 2022 (KR) 10-2022-0123826

(51) Int. Cl. G02B 27/64; G02B 7/09; G03B 3/10; G03B 5/02; G03B 5/04; H04N 23/67; H04N 23/68

(52) U.S. Cl. CPC G02B 27/646; G02B 7/09; G03B 3/10; G03B 5/02; G03B 5/04; H04N 23/67; H04N 23/687; G03B 2205/0015; G03B 2205/0069

(57) ABSTRACT

The present embodiment relates to a lens driving device comprising: a fixed part; a first moving part disposed on the fixed part; a second moving part disposed within the first moving part; a third moving part disposed within the second moving part; a first driving part that moves the first moving part in a first direction perpendicular to an optical axis direction; a second driving part that moves the second moving part in a second direction perpendicular to the optical axis direction and the first direction; and a third driving part that moves the third moving part in the optical axis direction, wherein the first driving part includes: a first magnet disposed on the fixed part; and a first coil disposed on the first moving part, and the second driving part includes: a second magnet disposed on the second moving part; and a second coil disposed on the first moving part.

### TECHNICAL FIELD

The present embodiment relates to a lens driving device, a camera device, and an optical device.

### BACKGROUND ART

A camera device is a device that photographs a picture or video of a subject, and is installed in optical instruments such as smartphones, drones, and vehicles.

An auto-focus function that automatically adjusts the focus according to the distance of the subject is applied to the camera device. In addition, a shake correction function is applied to prevent a phenomenon in which the focus is shaking by the user's shaking hands.

Autofocus and shaking hand correction functions can be performed through the electromagnetic interaction between the magnet and the coil.

However, in conventional lens driving devices, in the arrangement of magnets and coils for performing the image stabilization function, magnets that do not require electrical connection are disposed in the moving part, and the coils are disposed in the fixed part. In this case, there is a problem that the magnets, which are heavier than the coils, are disposed in the moving part, which increases the current consumption for performing the shaking hand correction function.

In particular, recently, as image sensors become highly pixelated, the lens diameter has increased, and the weight of the lens has also increased, which has exacerbated the problem.

In addition, in order to dispose the magnets and coils, and the like for performing the auto focus function and shaking hand correction function, a size larger than the thickness of the smartphone in an optical axis direction is required, which causes the camera device mounted on the smartphone to be protruded more than other portions of the smartphone.

(Patent Literature 1) KR 10-2015-0118005 A

### DETAILED DESCRIPTION OF THE INVENTION

### Technical Subject

In a structure for performing a shaking hand correction function, the present embodiment is intended to provide a lens driving device in which power consumption for performing an autofocus function is reduced by arranging a coil that is lightweight compared to a magnet in a moving part.

In addition, the present embodiment is intended to provide a camera device having an autofocus function and a shaking hand correction function, but with a minimized size in an optical axis direction.

### Technical Solution

A lens driving device according to the present embodiment comprises: a fixed part; a first moving part being disposed on the fixed part; a second moving part being disposed within the first moving part; a third moving part being disposed within the second moving part; a first driving part moving the first moving part in a first direction perpendicular to an optical axis direction; a second driving part moving the second moving part in a second direction perpendicular to the optical axis direction and the first direction; and a third driving part moving the third moving part in the optical axis direction, wherein the first driving part may comprise a first magnet being disposed in the fixed part and a first coil being disposed in the first moving part, and wherein the second driving part may comprise a second magnet being disposed in the second moving part and a second coil being disposed in the first moving part.

The third driving part may comprise a third magnet being disposed on the third moving part and a third coil being disposed in the second moving part.

The lens driving device may comprise a first ball being disposed between the fixed part and the first moving part in the second direction.

The lens driving device may comprise a second ball being disposed between the first moving part and the second moving part in the first direction.

The lens driving device may comprise a third ball being disposed between the second moving part and the third moving part in the second direction.

The fixed part comprises a lower plate and a protruding portion being protruded from the lower plate, the protruding portion of the fixed part is disposed within the first moving part, and the first ball may be disposed in the protruding portion of the fixed part.

The lens driving device comprises a first substrate comprising an outer portion being disposed in the fixed part, an inner portion being disposed in the first moving part, and a connecting portion connecting the outer portion and the inner portion, and at least a portion of the connecting portion of the first substrate can be movably formed in the first direction.

The lens driving device comprises a second substrate comprising an outer portion being disposed on the fixed part, an inner portion being disposed on the second moving part, and a connecting portion connecting the outer portion and the inner portion, wherein at least a portion of the connecting portion of the second substrate can be movably formed in the first direction and the second direction.

The lens driving device may comprise a first yoke being disposed in the first moving part and having an attractive force with the first magnet.

The above lens driving device may comprise a second yoke being disposed in the first moving part and having an attractive force with the second magnet.

The lens driving device may comprise a third yoke being disposed in the second moving part and having an attractive force with the third magnet.

The fixed part comprises a base and a cover being disposed in the base, wherein the cover comprises a first side plate and a second side plate being disposed opposite to each other, and a third side plate and a fourth side plate disposed on opposite sides, and wherein an outer surface of the third magnet can be disposed parallel to the second side plate.

The fixed part comprises a base and a cover being disposed in the base, wherein the cover comprises a first side plate and a second side plate being disposed opposite to each other, and a third side plate and a fourth side plate disposed on opposite sides, and wherein when viewed from above, an outer surface of the third magnet can be inclinedly disposed between the second side plate and the fourth side plate.

A lens driving device according to the present embodiment comprises: a fixed part; a first moving part being disposed in the fixed part; a second moving part being disposed within the first moving part; a third moving part being disposed within the second moving part; a first driving part that moves the first moving part in a first direction perpendicular to an optical axis direction; a second driving part that moves the second moving part in a second direction perpendicular to the optical axis direction and the first direction; and a third driving part that moves the third moving part in the optical axis direction, wherein the first moving part comprises a first portion being disposed outside the fixed part, and wherein a ball may be disposed between the first portion of the first moving part and the fixed part.

A camera device according to the present embodiment may comprise a printed circuit board; an image sensor being disposed in the printed circuit board; the lens driving device being disposed on the printed circuit board; and a lens being coupled to the lens driving device.

An optical device according to the present embodiment may comprise a main body; a camera device being disposed in the main body; and a display being disposed in the main body and outputting at least any one or more of an image and a video photographed by the camera device.

### Advantageous Effects

Through the present embodiment, as the coil having a lighter weight than the magnet is disposed in the moving part, current consumption for performing the auto-focus function may be reduced.

In addition, it is possible to perform an auto-focus function and a shaking hand correction function in a camera device of a size being minimized in an optical axis direction.

That is, according to the present embodiment, even though it is a camera device not being protruded from a smartphone, both an auto-focus function and a shaking hand correction function can be performed.

### BRIEF DESCRIPTION OF DRAWINGS

FIG. 1 is a conceptual diagram of a lens driving device according to the present embodiment.

FIG. 2 is a perspective view of a lens driving device according to the present embodiment.

FIG. 3 is a cross-sectional view taken along line A-A of FIG. 2.

FIG. 4 is a cross-sectional view taken along line B-B of FIG. 2.

FIG. 5 is a cross-sectional view taken along line C-C of FIG. 2.

FIG. 6 is a cross-sectional view taken along line D-D of FIG. 2.

FIG. 7 is a cross-sectional view taken along line E-E of FIG. 2.

FIG. 8 is an exploded perspective view of a lens driving device according to the present embodiment.

FIG. 9 is an exploded perspective view of a lens driving device according to the present embodiment viewed from a different direction than FIG. 8.

FIG. 10 is a cross-sectional view of a lens driving device according to the present embodiment cut in a direction perpendicular to an optical axis and viewed from above.

FIG. 11 is a cross-sectional view of a lens driving device according to the present embodiment cut at a plane more above than FIG. 10 in a direction perpendicular to an optical axis and from above.

FIG. 12 is a perspective view of a lens driving device according to the present embodiment with a cover omitted.

FIG. 13 is an exploded perspective view viewed from a different direction than FIG. 7.

FIG. 14 is a perspective view illustrating a fixed part and related configuration of a lens driving device according to the present embodiment.

FIG. 15 is a perspective view illustrating a moving part and related configuration of a lens driving device viewed from a different direction from FIG. 11.

FIG. 16 is a perspective view illustrating an OIS-x moving part and related configuration of a lens driving device according to the present embodiment.

FIG. 17 is a perspective view illustrating an OIS-x carrier and related coil of a lens driving device according to the present embodiment.

FIG. 18 is a perspective view illustrating an outer substrate and related coil of a lens driving device according to the present embodiment.

FIG. 19 is a perspective view illustrating an OIS-y moving part and related configuration of a lens driving device according to the present embodiment.

FIG. 20 is a perspective view illustrating an outer substrate and related coil of a lens driving device according to the present embodiment.

FIG. 21 is a perspective view illustrating an AF moving part and related configuration of a lens driving device according to the present embodiment.

FIG. 22 is an exploded perspective view of an OIS-x carrier of a lens driving device according to the present embodiment.

FIG. 23 is a bottom exploded perspective view of an OIS-y carrier of a lens driving device according to the present embodiment. FIG. 24 is a cross-sectional perspective view showing the OIS-x driving part and related configuration of the lens driving device according to the present embodiment.

FIG. 25 is a cross-sectional perspective view showing the OIS-y driving part and related configuration of the lens driving device according to the present embodiment.

FIG. 26 is a perspective view of the lens driving device according to a modified example with the cover omitted.

FIG. 27 is a cross-sectional view of FIG. 26 cut in a direction perpendicular to the optical axis and viewed from above.

FIGS. 28 to 30 are diagrams for explaining the auto focus driving of a lens driving device according to the present embodiment. FIG. 28 is a cross-sectional view illustrating the appearance of a moving part in an initial state where no current is applied to the AF coil. FIG. 29 is a cross-sectional view illustrating the appearance where a moving part moves upward in an optical axis direction when a forward current is applied to an AF coil. FIG. 30 is a cross-sectional view illustrating the appearance where a moving part moves downward in an optical axis direction when a reverse current is applied to an AF coil.

FIGS. 31 to 33 are diagrams for explaining the shaking hand correction driving of a lens driving device according to the present embodiment. FIG. 31 is a cross-sectional view illustrating the appearance of an OIS moving part in an initial state in which no current is applied to an OIS-x coil and an OIS-y coil. FIG. 32 is a cross-sectional view illustrating the appearance in which an OIS moving part moves in an x-axis direction perpendicular to the optical axis when current is applied to the OIS-x coil. FIG. 33 is a cross-sectional view illustrating the appearance in which the OIS-y moving part moves in a y-axis direction perpendicular to both the optical axis and the x-axis when current is applied to an OIS-y coil.

FIG. 34 is an exploded perspective view of a camera device according to the present embodiment.

FIG. 35 is a perspective view of an optical device according to the present embodiment.

FIG. 36 is a perspective view of an optical device according to a modified embodiment.

### BEST MODE

Hereinafter, preferred embodiments of the present invention will be described in detail with reference to the accompanying drawings.

However, the technical idea of the present invention is not limited to some embodiments to be described, but may be implemented in various forms, and within the scope of the technical idea of the present invention, one or more of the constituent elements may be selectively combined or substituted between embodiments.

In addition, the terms (comprising technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may comprise the plural form unless specifically stated in the phrase, and when described as “at least one (or more than one) of A and B and C”, it may comprise one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also comprise cases of being ‘connected’, ‘coupled’, or ‘interconnected’ due that another component between that other components.

In addition, when described as being formed or disposed in “on (above)” or “below (under)” of each component, “on (above)” or “below (under)” means that it comprises not only the case where the two components are directly in contact with, but also the case where one or more other components are formed or disposed between the two components. In addition, when expressed as “on (above)” or “below (under)”, the meaning of not only an upward direction but also a downward direction with respect to one component may be comprised.

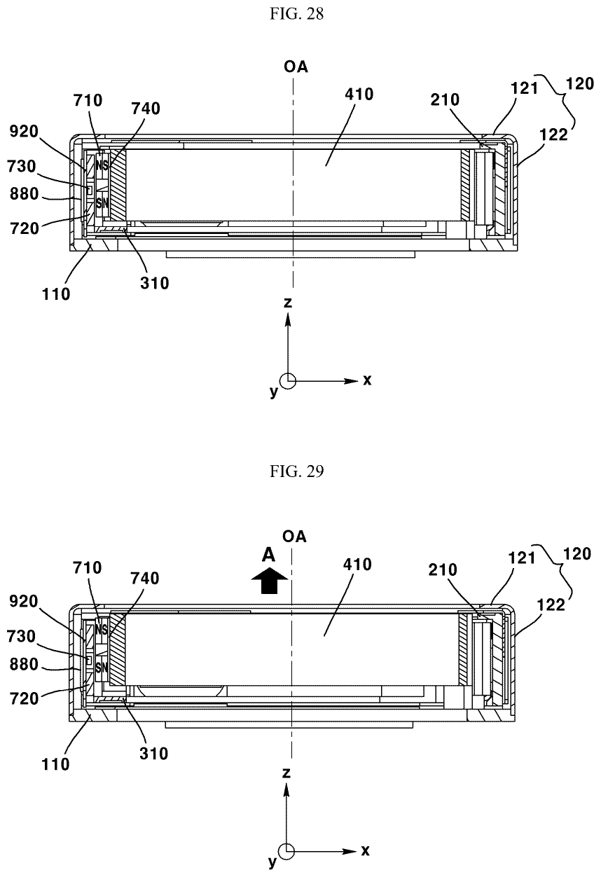

The ‘optical axis (see OA of FIG. 28) direction’ used hereinafter is defined as an optical axis direction of a lens and/or image sensor being coupled to a lens driving device.

The ‘vertical direction’ used hereinafter may be a direction parallel to or the same as an optical axis direction. The vertical direction may correspond to a ‘z-axis direction’. The ‘horizontal direction’ used hereinafter may be a direction perpendicular to a vertical direction. That is, a horizontal direction may be a direction perpendicular to the optical axis. Therefore, a horizontal direction may comprise an ‘x-axis direction’ and a ‘y-axis direction’.

The ‘auto focus (AF) function’ used hereinafter is defined as a function that automatically focuses on a subject by adjusting the distance from an image sensor by moving the lens in an optical axis direction according to the distance of the subject so that a clear image of the subject can be obtained on an image sensor. In addition, ‘closed-loop auto focus (CLAF) control’ is defined as detecting the distance between an image sensor and a lens and controlling the position of the lens through feedback in real time in order to improve the accuracy of focus adjustment.

The ‘optical image stabilization (OIS) function’ used hereinafter is defined as a function that moves or tilts a lens in a direction perpendicular to the optical axis to offset shaking hand in order to prevent an image or video from handshaking due to the user's shaking hand. In addition, ‘closed-loop auto focus (CLAF) control’ is defined as detecting the position of a lens with respect to an image sensor and controlling the feedback of the lens position in real time in order to improve the accuracy of shaking hand correction.

Hereinafter, any one among an “OIS-x moving part 200”, “OIS-y moving part 300” and “AF moving part 400” may be referred to as a “first moving part”, the other may be referred to as a “second moving part”, and yet the other may be referred to as a “third moving part”.

Hereinafter, any one among an “OIS-x driving part 500”, “OIS-y driving part 600” and “AF driving part 700” may be referred to as a “first driving part”, the other may be referred to as a “second driving part”, and yet the other may be referred to as a “third driving part”.

Hereinafter, any one among an “OIS-x magnet 510”, “OIS-y magnet 610” and “AF magnet 710” may be referred to as a “first magnet”, the other may be referred to as a “second magnet”, and yet the other may be referred to as a “fourth magnet”.

Hereinafter, any one among an “OIS-x coil 520”, “OIS-y coil 620” and “AF coil 720” may be referred to as a “first coil”, the other may be referred to as a “second coil”, and yet the other may be referred to as a “third coil”.

Hereinafter, one among an “AF sensor 530”, an “OIS-x sensor 630”, and an “OIS-y sensor 730” may be referred to as a “first sensor”, the other may be referred to as a “second sensor”, and yet the other may be referred to as a “third sensor”.

Hereinafter, one among an “OIS-x guide ball 810”, an “OIS-y guide ball 820”, and an “AF guide ball 830” may be referred to as a “first ball”, the other may be referred to as a “second ball”, and yet the other may be referred to as a “third ball”.

Hereinafter, one of an “outer substrate 910” and an “inner substrate 920” may be referred to as a “first substrate” and the other may be referred to as a “second substrate” Hereinafter, any one among an “OIS-x yoke 540”, an “OIS-y yoke 640”, an “AF yoke 740”, a “OIS-x ball pressure yoke 860”, “OIS-y ball pressure yoke 870” and “AF ball pressure yoke 880” is referred to as a “first yoke”, the other is referred to as a “second yoke”, yet the other is referred to as a “third yoke”, still the other is referred to as a “fourth yoke”, yet still the other is referred to as a “fifth yoke”, and still yet the other may be referred to as a “sixth yoke”.

Hereinafter, the configuration of a lens driving device according to the present embodiment is described with reference to the drawings.

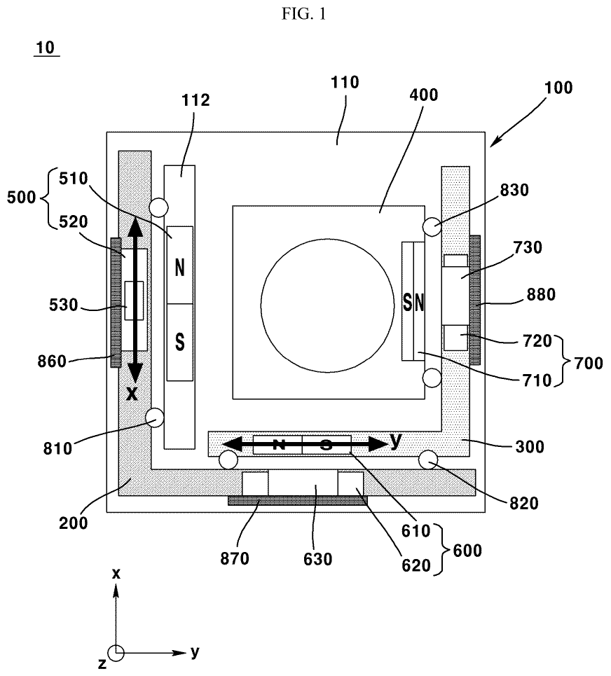

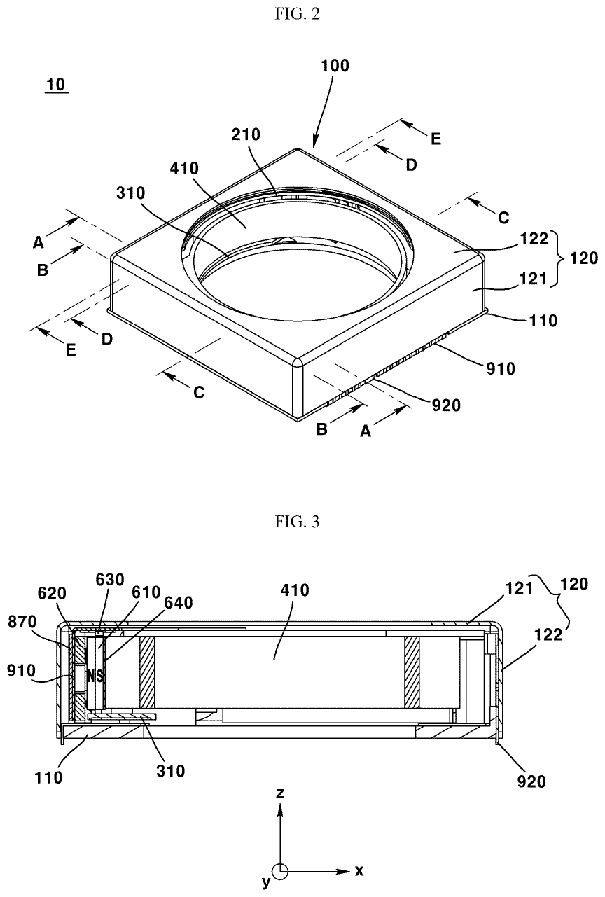

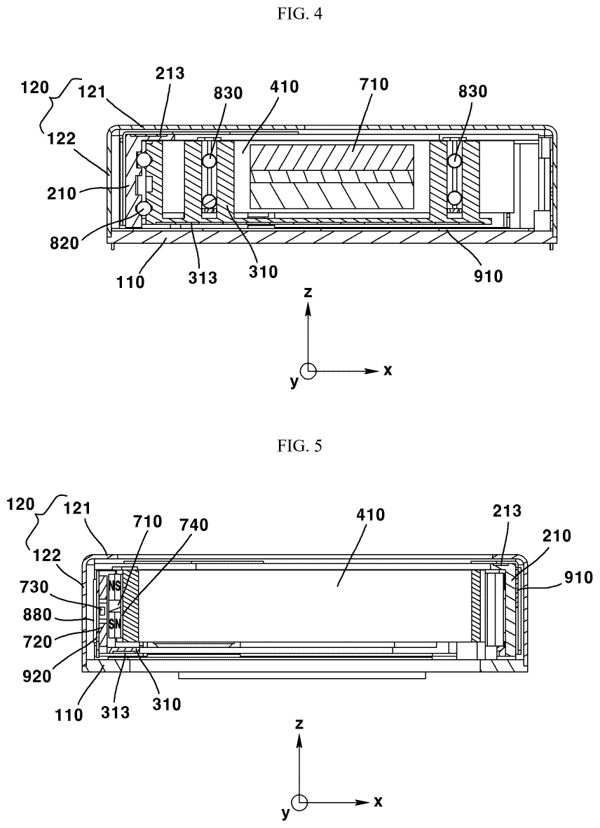

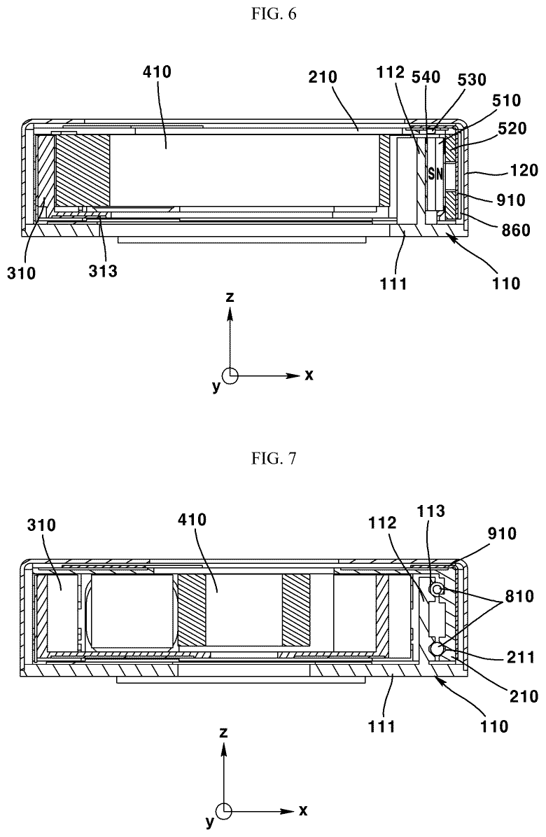

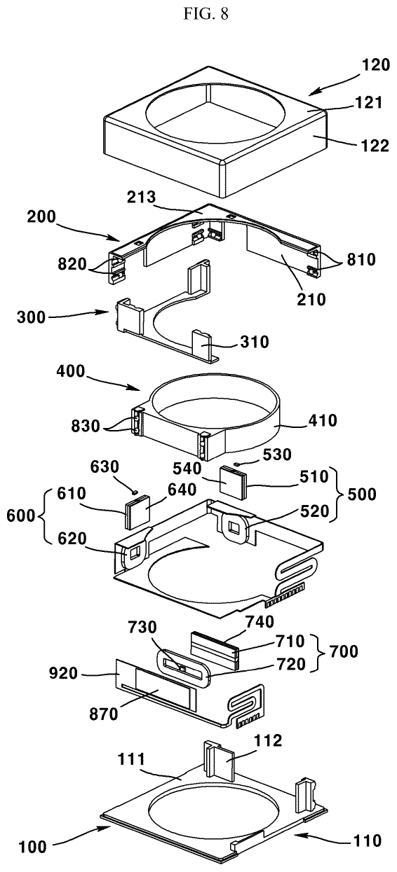

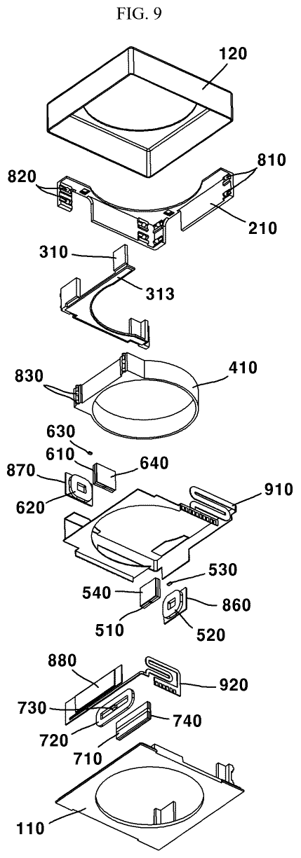

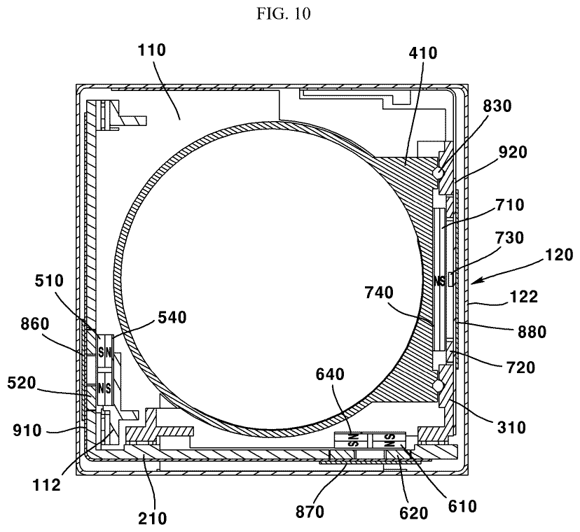

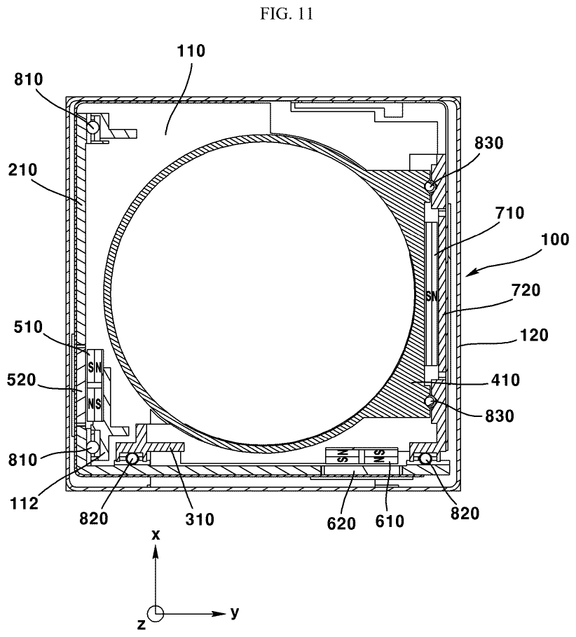

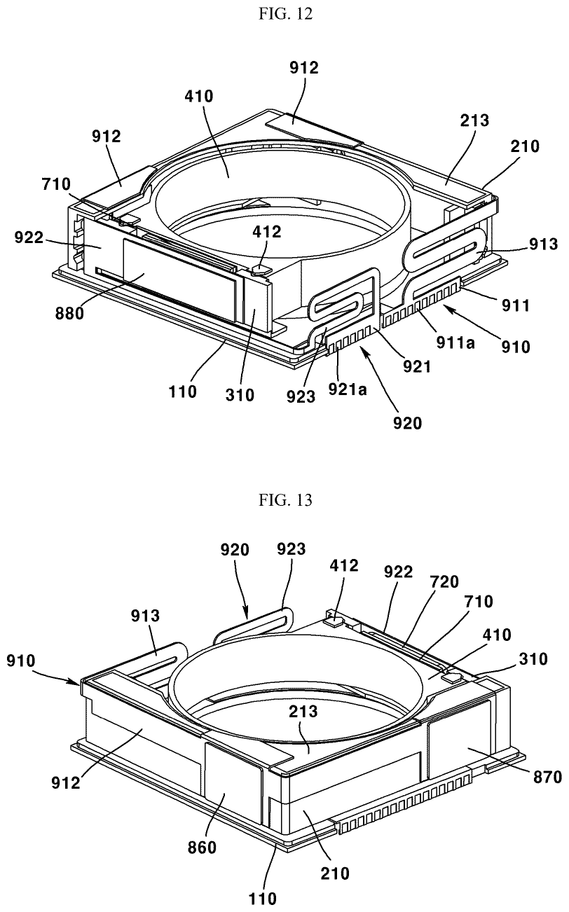

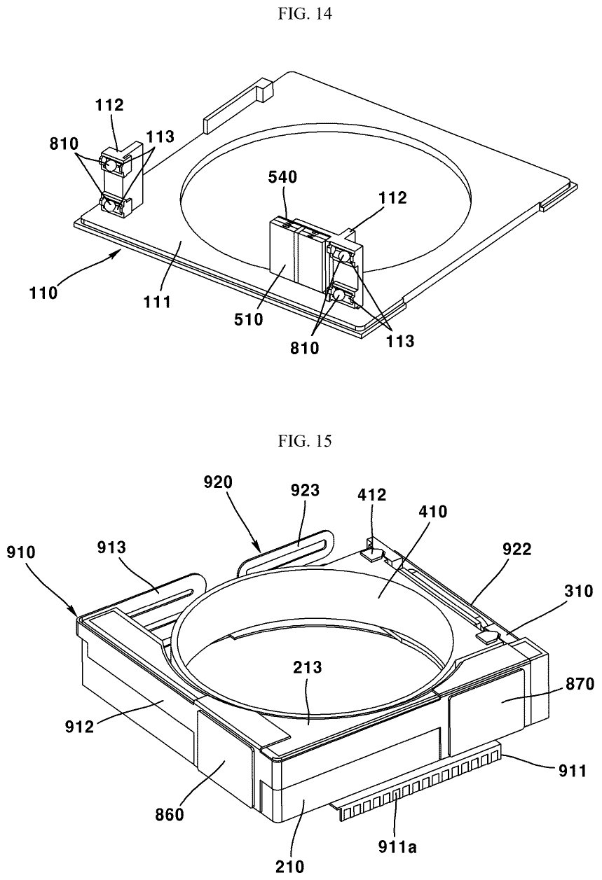

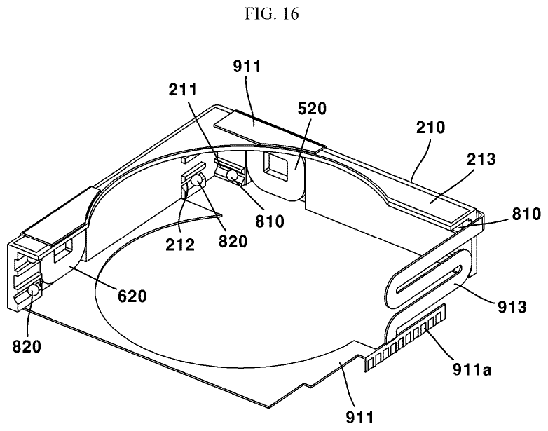

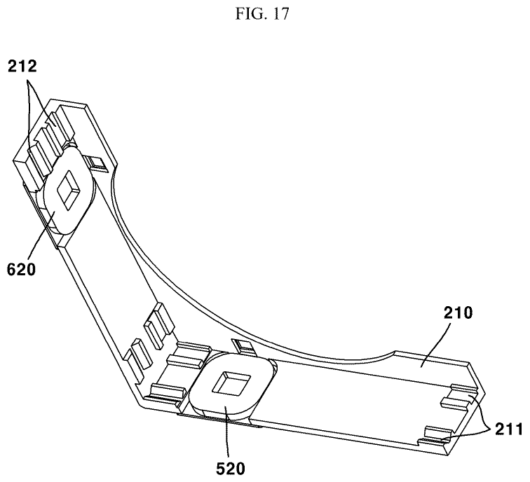

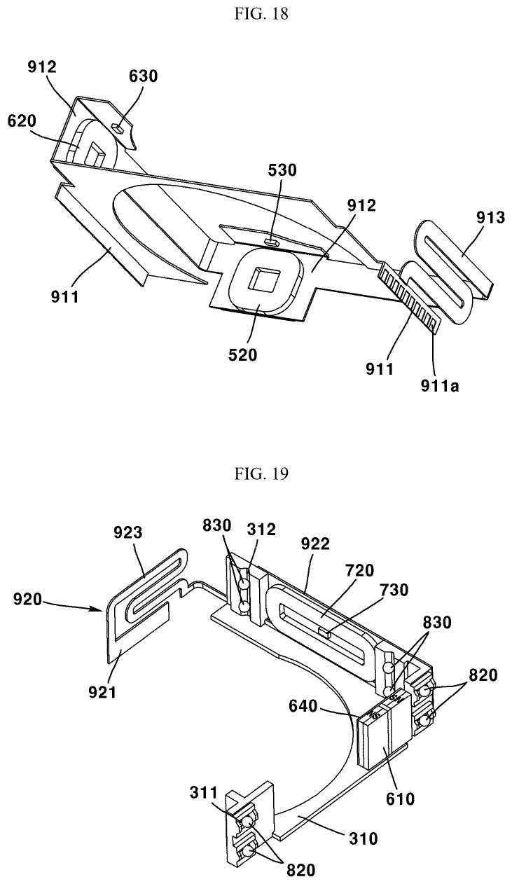

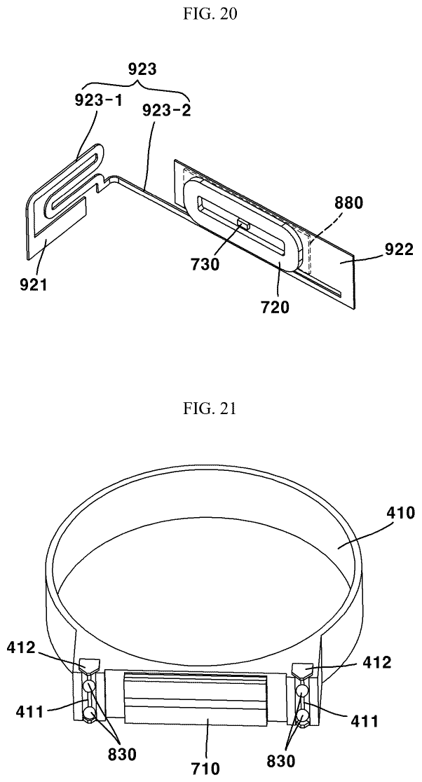

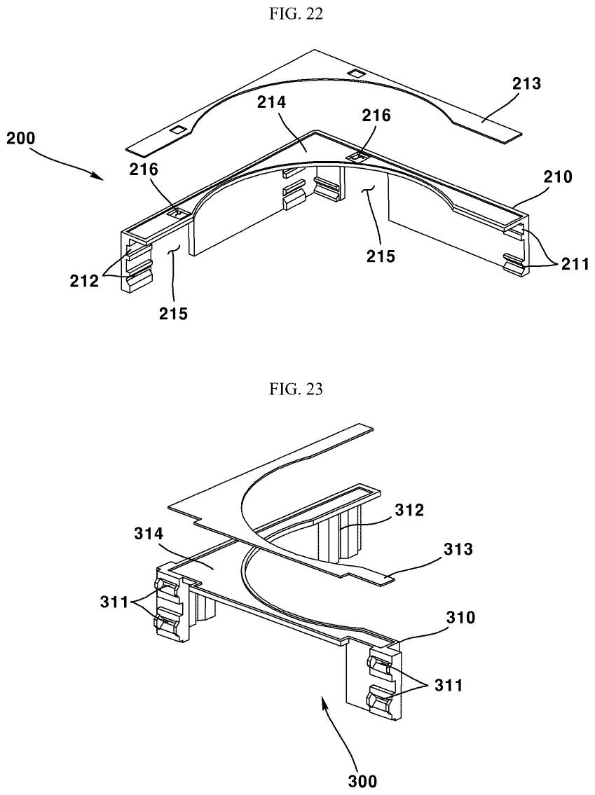

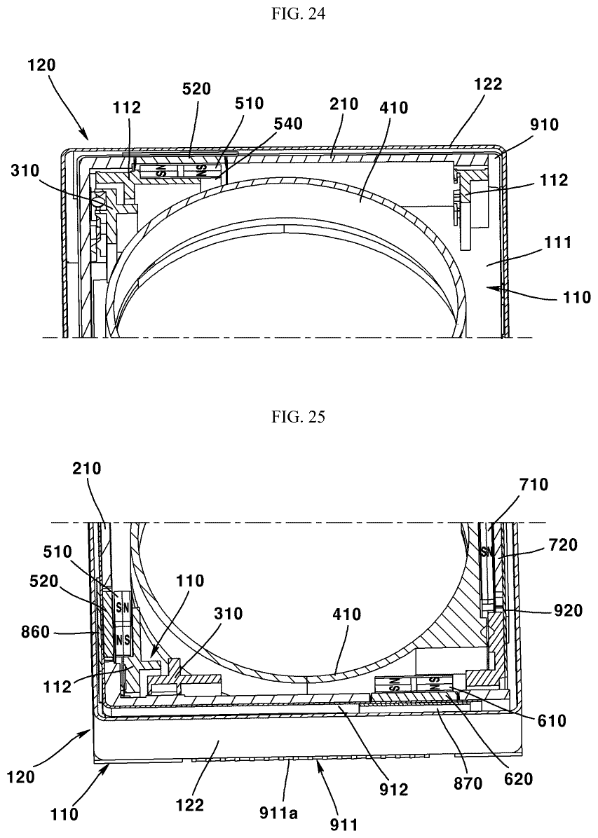

FIG. 1 is a conceptual diagram of a lens driving device according to the present embodiment; FIG. 2 is a perspective view of a lens driving device according to the present embodiment; FIG. 3 is a cross-sectional view taken along line A-A of FIG. 2; FIG. 4 is a cross-sectional view taken along line B-B of FIG. 2; FIG. 5 is a cross-sectional view taken along line C-C of FIG. 2; FIG. 6 is a cross-sectional view taken along line D-D of FIG. 2; FIG. 7 is a cross-sectional view taken along line E-E of FIG. 2; FIG. 8 is an exploded perspective view of a lens driving device according to the present embodiment; FIG. 9 is an exploded perspective view of a lens driving device according to the present embodiment viewed from a different direction than FIG. 8; FIG. 10 is a cross-sectional view of a lens driving device according to the present embodiment cut in a direction perpendicular to an optical axis and viewed from above; FIG. 11 is a cross-sectional view of a lens driving device according to the present embodiment cut at a plane more above than FIG. 10 in a direction perpendicular to an optical axis and from above; FIG. 12 is a perspective view of a lens driving device according to the present embodiment with a cover omitted; FIG. 13 is an exploded perspective view viewed from a different direction than FIG. 7; FIG. 14 is a perspective view illustrating a fixed part and related configuration of a lens driving device according to the present embodiment; FIG. 15 is a perspective view illustrating a moving part and related configuration of a lens driving device viewed from a different direction from FIG. 11; FIG. 16 is a perspective view illustrating an OIS-x moving part and related configuration of a lens driving device according to the present embodiment; FIG. 17 is a perspective view illustrating an OIS-x carrier and related coil of a lens driving device according to the present embodiment; FIG. 18 is a perspective view illustrating an outer substrate and related coil of a lens driving device according to the present embodiment; FIG. 19 is a perspective view illustrating an OIS-y moving part and related configuration of a lens driving device according to the present embodiment; FIG. 20 is a perspective view illustrating an outer substrate and related coil of a lens driving device according to the present embodiment; FIG. 21 is a perspective view illustrating an AF moving part and related configuration of a lens driving device according to the present embodiment; FIG. 22 is an exploded perspective view of an OIS-x carrier of a lens driving device according to the present embodiment; FIG. 23 is a bottom exploded perspective view of an OIS-y carrier of a lens driving device according to the present embodiment; FIG. 24 is a cross-sectional perspective view showing the OIS-x driving part and related configuration of the lens driving device according to the present embodiment; and FIG. 25 is a cross-sectional perspective view showing the OIS-y driving part and related configuration of the lens driving device according to the present embodiment.

The lens driving device 10 may be a voice coil motor (VCM). The lens driving device 10 may be a lens driving motor. The lens driving device 10 may be a lens driving actuator. The lens driving device 10 may comprise an AF module. The lens driving device 10 may comprise an OIS module.

The lens driving device 10 may comprise a fixed part 100. The fixed part 100 may be a portion that is relatively fixed when the moving part moves. The moving part may move against the fixed part 100.

The lens driving device 10 may comprise a base 110. The fixed part 100 may comprise a base 110. The base 110 may be disposed below the OIS-x carrier 210. The base 110 may be disposed below the OIS-y carrier 310. The base 110 may be disposed below the AF carrier 410. The base 110 may be coupled with the cover 120. The OIS-x carrier 210, the OIS-y carrier 310, and the AF carrier 410 may be disposed on the base 110. The OIS-x carrier 210, the OIS-y carrier 310, and the AF carrier 410 may be disposed on the lower plate portion 111 of the base 110. The OIS-x carrier 210, the OIS-y carrier 310, and the AF carrier 410 may be disposed within the base 110.

The base 110 may comprise a lower plate 111. The base 110 may comprise a protruding portion 112. The protruding portion 112 may be a ‘side plate’. The protruding portion 112 may be a ‘side plate’. The protruding portion 112 may be a ‘side wall’. The protruding portion 112 of the base 110 may be extended from an upper surface of the lower plate 111. The protruding portion 112 of the base 110 may be protruded from the lower plate 111. The protruding portion 112 of the base 110 may be protruded upward from an upper surface of the lower plate 111. The protruding portion 112 of the base 110 may be disposed within the OIS-x moving part 200. The protruding portion 112 of the base 110 may be disposed within the OIS-x carrier 210. The protruding portion 112 of the base 110 may be disposed between the OIS-x carrier 210 and the OIS-y carrier 310. The protruding portion 112 of the base 110 may be disposed between the OIS-x carrier 210 and the AF carrier 410. The OIS-x guide ball 810 can be disposed on the protruding portion 112 of the fixed part 100. The OIS-x magnet 510 can be disposed on the protruding portion 112 of the fixed part 100.

The base 110 may comprise a groove 113. The groove 113 may be an ‘OIS-x guide ball accommodating groove’. An OIS-x guide ball 810 may be disposed in the groove 113. The groove 113 may be in direct contact with the OIS-x guide ball 810. The groove 113 may be disposed in a direction perpendicular to the optical axis. The groove 113 may comprise a plurality of grooves. The groove 113 may comprise four grooves. The four grooves may be disposed parallel to each other. The groove 113 may comprise a first groove being in contact with the OIS-x guide ball 810 at two points and a second groove being in contact with the OIS-x guide ball 810 at one point. In a modified embodiment, both the first groove and the second groove may be in contact with the OIS-x guide ball 810 at two points.

The base 110 may comprise a step. The step may be formed at a lower end portion of the outer side surface of the base 110. The step may be protruded from an outer side surface of the base 110. A side plate 122 of the cover 120 may be disposed in the step of the base 110.

The lens driving device 10 may comprise a cover 120. The fixed part 100 may comprise a cover 120. The cover 120 may be disposed in the base 110. The cover 120 may be disposed on the base 110. The cover 120 may be coupled to the base 110. The cover 120 may be fixed to the base 110. The cover 120 may accommodate an OIS-x carrier 210 therein. The cover 120 may accommodate an OIS-y carrier 310 and an AF carrier 410 therein. The cover 120 may be a shield member. The cover 120 may be a shield can.

The cover 120 may comprise an upper plate 121. The upper plate 121 may be disposed on the moving part. The upward movement of the moving part may be limited by the moving part being in contact with the upper plate 121. The upper plate 121 may comprise a hole through which light passes.

The cover 120 may comprise a side plate 122. The side plate 122 may be extended from the upper plate 121. The side plate 122 may be disposed in the base 110. The side plate 122 may be disposed on a step portion being protruded from a lower end portion of an outer side surface of the base 110. The side plate 122 may comprise a plurality of side plates. The side plate 122 may comprise four side plates. The side plate 122 may comprise a first side plate and a second side plate being disposed opposite to each other and a third side plate and a fourth side plate being disposed opposite to each other.

The lens driving device 10 may comprise a moving part. The moving part may be disposed in the fixed part 100. The moving part may be disposed in the fixed part 100. The moving part may be disposed within the fixed part 100. The moving part may be movably disposed on the fixed part 100. The moving part may be moved with respect to the fixed part 100 by the driving part. The moving part may be moved during AF driving. The moving part may be moved during OIS driving. A lens may be coupled to the moving part.

The lens driving device 10 may comprise an OIS moving part. The moving part may comprise an OIS moving part. The OIS moving part may be disposed in the fixed part 100. The OIS moving part may be disposed within the fixed part 100. The OIS moving part may be disposed on the fixed part 100. The OIS moving part may be disposed between the fixed part 100 and the AF moving part 400. The OIS moving part may be movably disposed. The OIS moving part may move in a direction perpendicular to an optical axis against the fixed part 100 by the OIS driving part. The OIS moving part may move during OIS driving.

The lens driving device 10 may comprise an OIS-x moving part 200. The OIS moving part may comprise an OIS-x moving part 200. The OIS-x moving part 200 may be disposed in the fixed part 100. The OIS-x moving part 200 may be disposed within the fixed part 100. The OIS-x moving part 200 may be disposed on the fixed part 100. The OIS-x moving part 200 may be disposed between the fixed part 100 and the AF moving part 400. The OIS-x moving part 200 may be disposed between the fixed part 100 and the OIS-y moving part 300. The OIS-x moving part 200 may be movably disposed. The OIS-x moving part 200 can move in an x-axis direction perpendicular to the optical axis against the fixed part 100 by the OIS-x driving part 500. The OIS-x moving part 200 can move during OIS driving.

The lens driving device 10 may comprise an OIS-x carrier 210. The OIS-x moving part 200 may comprise an OIS-x carrier 210. The OIS-x carrier 210 may be an ‘OIS-x holder’. The OIS-x carrier 210 may be a ‘housing’. The OIS-x carrier 210 may be disposed outside the AF carrier 410. The OIS-x carrier 210 may be disposed within the base 110. The OIS-x carrier 210 may be disposed on the base 110. The OIS-x carrier 210 may be disposed within the cover 140. The OIS-x carrier 210 may be disposed between the base 110 and the OIS-y carrier 310. The OIS-x carrier 210 may be disposed between the AF carrier 410 and the base 110. The OIS-x carrier 210 may be disposed between the AF carrier 410 and the cover 120. The OIS-x carrier 210 may be movably disposed in an x-axis direction perpendicular to the optical axis.

The first moving part 200 may comprise a first portion being disposed on the outside of the fixed part 100. At least a portion of the first moving part 200 may be disposed on the outside of the fixed part 100. An AF guide ball 830 may be disposed between the first portion of the first moving part 200 and the fixed part 100. The OIS-x carrier 210 may comprise a first portion being disposed on the outside of the base 110. At least a portion of the OIS-x carrier 210 may be disposed on the outside of the pillar portion of the base 110. The OIS-x carrier 210 may comprise a first portion being disposed on the outside of the pillar portion of the base 110. The pillar portion of the base 110 may be extended upward from a lower plate 111 of the base 110.

The OIS-x carrier 210 may comprise a groove 211. The groove 211 may be an ‘OIS-x guide ball accommodating groove’. The groove 211 may be formed on a side plate of the OIS-x carrier 210. The groove 211 may be formed on an inner surface of the side plate of the OIS-x carrier 210. An OIS-x guide ball 810 may be disposed in the groove 211. The groove 211 may be in direct contact with the OIS-x guide ball 810. The groove 211 may be disposed in a direction perpendicular to the optical axis. The groove 211 may be disposed in an x-axis direction. The groove 211 may guide the OIS-x guide ball 810 to move in an x-axis direction. The groove 211 may comprise a plurality of grooves. The groove 211 may comprise four groove portions. The groove 211 may comprise a first groove portion being in contact with the OIS-x guide ball 810 at two points, and a second groove portion being in contact with the OIS-x guide ball 810 at one point. In a modified embodiment, both the first groove portion and the second groove portion may be in contact with the OIS-x guide ball 810 at two points.

The OIS-x carrier 210 may comprise a groove 212. The groove 212 may be an ‘OIS-y guide ball accommodating groove’. The groove 212 may be formed on a side plate of the OIS-x carrier 210. The groove 212 may be formed on an inner surface of the side plate of the OIS-x carrier 210. An OIS-y guide ball 820 may be disposed in the groove 212. The groove 212 may be in direct contact with the OIS-y guide ball 820. The groove 212 may be disposed in a direction perpendicular to the optical axis. The groove 212 may be disposed in a y-axis direction. The groove 212 may guide the OIS-y guide ball 820 to move in a y-axis direction. The groove 212 may comprise a plurality of grooves. The groove 212 may comprise four groove portions. The groove 212 may comprise a first groove portion being in contact with the OIS-y guide ball 820 at two points, and a second groove portion being in contact with the OIS-y guide ball 820 at one point. In a modified embodiment, both the first groove portion and the second groove portion may be contact with the OIS-y guide ball 820 at two points.

The OIS-x carrier 210 may comprise a first side plate on which the OIS-x guide ball 810 is disposed, and a second side plate on which the OIS-y guide ball 820 is disposed.

The OIS-x carrier 210 may comprise a metal plate 213. The metal plate 213 may be a ‘reinforcing member’. The metal plate 213 may be provided to reinforce the strength of the OIS-x carrier 210. The metal plate 213 may be disposed on an upper surface of the OIS-x carrier 210. The metal plate 213 may be disposed on the OIS-x carrier 210 by insert injection.

The OIS-x carrier 210 may comprise a groove 214. The groove 214 may be a ‘metal plate accommodating groove’. A metal plate 213 may be disposed in the groove 214. The groove 214 may be concavely formed on an upper surface of the OIS-x carrier 210. The groove 214 may comprise a shape corresponding to the metal plate 213.

The OIS-x carrier 210 may comprise a groove 215. The groove 215 may be a ‘coil accommodating groove’. The groove 215 may be formed on a side plate of the OIS-x carrier 210. A coil may be disposed in the groove 215. An OIS-x coil 520 may be disposed in the groove 215. An OIS-y coil 620 may be disposed in the groove 215.

The OIS-x carrier 210 may comprise a hole 216. The hole 216 may be a ‘sensor accommodating hole’. The hole 216 may be formed on an upper plate of the OIS-x carrier 210. A sensor may be disposed in the hole 216. An OIS-x sensor 530 may be disposed in the hole 216. An OIS-y sensor 630 may be disposed in the hole 216.

Hereinafter, one among a “groove 211”, a “groove 212”, a “groove 214” and a “groove 215” of the OIS-x carrier 210 is referred to as a “first groove”, the other is referred to as a “second groove”, yet the other is referred to as a “third groove”, and still yet the other may be referred to as a “fourth groove”.

The lens driving device 10 may comprise an OIS-y moving part 300. The OIS moving part may comprise an OIS-y moving part 300. The OIS-y moving part 300 may be disposed on the fixed part 100. The OIS-y moving part 300 may be disposed within the fixed part 100. The OIS-y moving part 300 may be disposed on the fixed part 100. The OIS-y moving part 300 may be disposed outside the AF moving part 400. The OIS-y moving part 300 may be disposed between the AF moving part 400 and the OIS-x moving part 200. The OIS-y moving part 300 may be disposed within the OIS-x moving part 200. The OIS-y moving part 300 may be movably disposed. The OIS-y moving part 300 can move in a y-axis direction perpendicular to both the optical axis and the x-axis against the fixed part 100 and the OIS-x moving part 200 by the OIS-y driving part 600. The OIS-y moving part 300 can move when the OIS is driven.

The lens driving device 10 may comprise an OIS-y carrier 310. The OIS-y moving part 300 may comprise an OIS-y carrier 310. The OIS-y carrier 310 may be an ‘OIS-y holder’. The OIS-y carrier 310 may be a ‘housing’. The OIS-y carrier 310 may be disposed within the OIS-x carrier 210. The OIS-y carrier 310 may be disposed outside the AF carrier 410. The OIS-y carrier 310 may be disposed between the AF carrier 410 and the OIS-x carrier 210. The OIS-y carrier 310 may be disposed within the base 110. The OIS-y carrier 310 may be disposed on the base 110. The OIS-y carrier 310 can be disposed within the cover 140. The OIS-y carrier 310 can be movably disposed in a y-axis direction perpendicular to both the optical axis and the x-axis.

The OIS-y carrier 310 may comprise a groove 311. The groove 311 may be an ‘OIS-y guide ball accommodating groove’. The groove 311 may be formed on a side plate of the OIS-y carrier 310. The groove 311 may be formed on an outer surface of the side plate of the OIS-y carrier 310. An OIS-y guide ball 820 may be disposed in the groove 311. The groove 311 may be in direct contact with the OIS-y guide ball 820. The groove 311 may be disposed in a direction perpendicular to the optical axis. The groove 311 may be disposed in a y-axis direction. The groove 311 may guide the OIS-y guide ball 820 to move in a y-axis direction. The groove 311 may comprise a plurality of grooves. The groove 311 may comprise four groove portions. The groove 311 may comprise a first groove portion being in contact with the OIS-y guide ball 820 at two points, and a second groove portion being in contact with the OIS-y guide ball 820 at one point. In a modified embodiment, both the first groove portion and the second groove portion may contact the OIS-y guide ball 820 at two points.

The OIS-y carrier 310 may comprise a groove 312. The groove 312 may be an ‘AF guide ball accommodating groove’. The groove 311 may be formed on a side plate of the OIS-y carrier 310. The groove 311 may be formed on an inner surface of the side plate of the OIS-y carrier 310. An AF guide ball 830 may be disposed in the groove 312. The groove 312 may be in direct contact with the AF guide ball 830. The groove 312 may be disposed in an optical axis direction. The groove 312 may guide the AF guide ball 830 to move in an optical axis direction. The groove 312 may comprise a plurality of grooves. The groove 312 may comprise two grooves. The two grooves may be disposed parallel to each other. The groove 312 may comprise a first groove being in contact with the AF guide ball 830 at two points, and a second groove being in contact with the AF guide ball 830 at one point. In a modified embodiment, both the first groove and the second groove may be in contact with the AF guide ball 830 at two points.

The OIS-y carrier 310 may comprise a metal plate 313. The metal plate 313 may be a ‘reinforcing member’. The metal plate 313 may be provided to reinforce the strength of the OIS-y carrier 310. The metal plate 313 may be disposed on the upper surface of the OIS-y carrier 310. The metal plate 313 may be disposed in the OIS-y carrier 310 by insert injection.

The OIS-y carrier 310 may comprise a groove 314. The groove 314 may be a ‘metal plate accommodating groove’. A metal plate 313 may be disposed in the groove 314. The groove 314 may be concavely formed on an upper surface of the OIS-y carrier 310. The groove 314 may comprise a shape corresponding to the metal plate 313.

Hereinafter, one among the “groove 311”, “groove 312” and “groove 314” of the OIS-y carrier 310 is referred to as a “first groove”, the other is referred to as a “second groove” and yet the other may be referred to as a “third groove”.

The lens driving device 10 may comprise an AF moving part 400. The moving part may comprise an AF moving part 400. The AF moving part 400 may be disposed on the fixed part 100. The AF moving part 400 may be disposed within the fixed part 100. The AF moving part 400 may be disposed on the fixed part 100. The AF moving part 400 may be disposed within the OIS moving part. The AF moving part 400 may be disposed within the OIS-x moving part 200. The AF moving part 400 may be disposed within the OIS-y moving part 300. The AF moving part 400 may be movably disposed. The AF moving part 400 may move in an optical axis direction against the fixed part 100 by the AF driving part 700. The AF moving part 400 can move in an optical axis direction against the OIS moving part by the AF driving part 700. The AF moving part 400 can move during AF driving.

The lens driving device 10 may comprise an AF carrier 410. The AF moving part 400 may comprise an AF carrier 410. The AF carrier 410 may be an ‘AF holder’. The AF carrier 410 may be a ‘bobbin’. The AF carrier 410 may be disposed within the base 110. The AF carrier 410 may be disposed on the base 110. The AF carrier 410 may be disposed within the cover 120. The AF carrier 410 may be disposed within the OIS-x carrier 210. The AF carrier 410 may be disposed within the OIS-y carrier 310. The AF carrier 410 may be movably disposed. The AF carrier 410 may be movably disposed to move in an optical axis direction.

The AF carrier 410 may comprise a groove 411. The groove 411 may be an ‘AF guide ball accommodating groove’. The groove 411 may be formed on a side surface of the AF carrier 410. The groove 411 may be formed on an outer side surface of the AF carrier 410. An AF guide ball 830 may be disposed in the groove 411. The groove 411 may be in direct contact with the AF guide ball 830. The groove 411 may be disposed in an optical axis direction. The groove 411 may guide the AF guide ball 830 to move in an optical axis direction. The groove 411 may comprise a plurality of grooves. The groove 411 may comprise two grooves. The two grooves may be disposed parallel to each other. The groove 411 may comprise a first groove being in contact with the AF guide ball 830 at two points, and a second groove being in contact with the AF guide ball 830 at one point. In a modified embodiment, both the first groove and the second groove may come into contact with the AF guide ball 830 at two points.

The AF carrier 410 may comprise a groove. An AF magnet 710 may be disposed in the groove. When viewed from the outside, the AF magnet 710 may be disposed between two grooves 411.

The lens driving device 10 may comprise a ball cover 412. The ball cover 412 may be disposed on the AF guide ball 830. The ball cover 412 may be overlapped with the AF guide ball 830 in an optical axis direction. The ball cover 412 may prevent the AF guide ball 830 from being separated. The ball cover 412 may be disposed on an upper surface of the AF carrier 410. The ball cover 412 may be disposed at a position corresponding to the groove 411 of the AF carrier 410. The ball cover 412 may be formed of a metal plate. The ball cover 412 may be formed in a shape that does not interfere with the OIS-y carrier 310.

The lens driving device 10 may comprise a driving part. The driving part may move a moving part against the fixed part 100. The driving part may comprise an AF driving part 700. The driving part may comprise an OIS driving part. The driving part may comprise an OIS-x driving part 500. The driving part may comprise an OIS-y driving part 600. The driving part may comprise a coil and a magnet.

The lens driving device 10 may comprise an OIS driving part. The OIS driving part may move the OIS moving part in a direction perpendicular to the optical axis. The OIS driving part may move the OIS-x carrier 210 and the OIS-y carrier 310 in a direction perpendicular to the optical axis. The OIS driving part may move the OIS-x carrier 210 and the OIS-y carrier 310 in a direction perpendicular to the optical axis through electromagnetic force. The OIS driving part may comprise a magnet and a coil.

The lens driving device 10 may comprise an OIS-x driving part 500. The OIS driving part may comprise an OIS-x driving part 500. The OIS-x driving part 500 can move the OIS-x moving part 200 in an x-axis direction perpendicular to the optical axis direction. The OIS-x driving part 500 can move the OIS-x carrier 210 in an x-axis direction. The OIS-x driving part 500 can move the OIS-x carrier 210 and the OIS-y carrier 310 in an x-axis direction perpendicular to the optical axis. The OIS-x driving part 500 can move the OIS-x carrier 210 and the OIS-y carrier 310 in an x-axis direction perpendicular to the optical axis through electromagnetic force. The OIS-x driving part 500 may comprise a coil and a magnet.

In the present embodiment, the OIS-x magnet 510 and the OIS-x coil 520 can move the OIS moving part in an x-axis direction perpendicular to the optical axis direction. By the interaction of the OIS-x coil 520 and the OIS-x magnet 510, the OIS-x carrier 210 and the OIS-y carrier 310 can move in an x-axis direction perpendicular to the optical axis direction. The OIS-x magnet 510, the OIS-x carrier 210, and the OIS-y carrier 310 can move integrally in an x-axis direction.

The lens driving device 10 may comprise an OIS-x magnet 510. The OIS driving part may comprise an OIS-x magnet 510. The OIS-x magnet 510 may be an ‘OIS-x magnet’. The OIS-x magnet 510 may be a permanent magnet. The OIS-x magnet 510 may be disposed in the fixed part 100. The OIS-x magnet 510 may be disposed in the base 110. The OIS-x magnet 510 may be fixed to the base 110. The OIS-x magnet 510 may be coupled to the base 110. The OIS-x magnet 510 may be attached to the base 110 with an adhesive. The OIS-x magnet 510 may be disposed on the protruding portion 112 of the base 110. The OIS-x magnet 510 may be spaced apart from the AF magnet 710. The OIS-x magnet 510 may be disposed within the cover 120.

The OIS-x magnet 510 can interact with the OIS-x coil 520. The OIS-x magnet 510 can electromagnetically interact with the OIS-x coil 520. The OIS-x magnet 510 can be disposed at a position corresponding to the OIS-x coil 520. The OIS-x magnet 510 and the OIS-x coil 520 can face each other. The OIS-x magnet 510 can face the OIS-x coil 520. The OIS-x magnet 510 can be overlapped with the OIS-x coil 520 in a direction perpendicular to the optical axis. The OIS-x magnet 510 can be overlapped with the OIS-x coil 520 in a y-axis direction. The OIS-x magnet 510 can move the OIS-x coil 520 in an x-axis direction.

The OIS-x magnet 510 may be a four-pole magnet. The OIS-x magnet 510 may comprise a four-pole magnetizing magnet. The OIS-x magnet 510 may comprise a first magnet portion comprising an N pole and an S pole, and a second magnet portion comprising an N pole and an S pole. The first magnet portion and the second magnet portion may be disposed in a horizontal direction. The first magnet portion and the second magnet portion may be spaced apart in a horizontal direction. A neutral portion may be disposed between the first magnet portion and the second magnet portion.

The lens driving device 10 may comprise an OIS-x coil 520. The OIS driving part may comprise an OIS-x coil 520. The OIS-x coil 520 may interact with an OIS-x magnet 510. The OIS-x coil 520 may move in an x-axis direction perpendicular to the optical axis. The OIS-x coil 520 may move in an x-axis direction through interaction with the OIS-x magnet 510. The OIS-x coil 520 and the OIS-x magnet 510 may face each other. The OIS-x coil 520 may face the OIS-x magnet 510. The OIS-x coil 520 may be disposed at a position corresponding to the OIS-x magnet 510. The OIS-x coil 520 can be overlapped with the OIS-x magnet 510 in a direction perpendicular to the optical axis. The OIS-x coil 520 can be overlapped with the OIS-x magnet 510 in a y-axis direction. The OIS-x coil 520 can be disposed on the outer substrate 910. The OIS-x coil 520 can be disposed in the OIS-x moving part 200. The OIS-x coil 520 can be disposed in the OIS-x carrier 210. The OIS-x coil 520 can be disposed in the OIS-x carrier 210 through the inner substrate 720. The OIS-x coil 520 can move integrally with the OIS-x carrier 210.

In the present embodiment, the OIS-x coil 520 can move together with the OIS-x moving part 200. In this case, compared to the comparative example in which the OIS-x magnet 510 is disposed in the OIS-x moving part 200 and moves together, the weight of the moving part is lighter, so within that the current consumed for driving the OIS-x can be reduced.

The lens driving device 10 may comprise an OIS-x sensor 530. The OIS driving part may comprise an OIS-x sensor 530. The OIS-x sensor 530 may be disposed in an outer substrate 910. The OIS-x sensor 530 may be disposed in an OIS-x carrier 210. The OIS-x sensor 530 may be disposed in an OIS-x moving part 200. The OIS-x sensor 530 may comprise a Hall sensor. The OIS-x sensor 530 may detect an OIS-x magnet 510. The OIS-x sensor 530 may detect a magnetic force of the OIS-x magnet 510. The OIS-x sensor 530 may be disposed on an upper side of the OIS magnet 520. The OIS-x sensor 530 may be overlapped with the OIS-magnet 520 in an optical axis direction. In a modified embodiment, the OIS-x sensor 530 may be disposed within the OIS-x coil 520. At this time, the OIS-x sensor 530 may be overlapped with the OIS-x coil 520 in an optical axis direction. The OIS-x sensor 530 may face the OIS-x magnet 510. The OIS-x sensor 530 may be disposed at a position corresponding to the OIS-x magnet 510. The OIS-x sensor 530 may detect the movement of the OIS-x magnet 510. The amount of movement or position of the OIS-x magnet 510 detected by the OIS-x sensor 530 may be used for feedback of the shaking hand correction driving in an x-axis direction.

The lens driving device 10 may comprise an OIS-x yoke 540. The OIS-x yoke 540 may be disposed in the OIS-x magnet 510. The OIS-x yoke 540 may be disposed between the OIS-x magnet 510 and the OIS-x carrier 210. The OIS-x yoke 540 may prevent magnetic flux leakage of the OIS-x magnet 510 and enhance interaction with the OIS-x coil 520.

The lens driving device 10 may comprise an OIS-y driving part 600. The OIS driving part may comprise an OIS-y driving part 600. The OIS-y driving part 600 may move the OIS-y moving part 300 in a y-axis direction perpendicular to both the optical axis direction and the x-axis direction. The OIS-y driving part 600 may move the OIS-y carrier 310 in a y-axis direction perpendicular to both the optical axis and the x-axis direction. The OIS-y driving part 600 may move the OIS-y carrier 310 in a y-axis direction perpendicular to both the optical axis and the x-axis direction through electromagnetic force. The OIS-y driving part 600 may comprise a coil and a magnet.

In the present embodiment, the OIS-y magnet 610 and the OIS-y coil 620 can move the OIS moving part in a y-axis direction perpendicular to the optical axis direction and the x-axis direction. By the interaction of the OIS-y coil 620 and the OIS-y magnet 610, the OIS-Y carrier 310 can move in a y-axis direction perpendicular to both the optical axis direction and the x-axis direction. The OIS-y magnet 610 and the OIS-y carrier 310 can move integrally in a y-axis direction. At this time, the AF carrier 410 can also move integrally with the OIS-y carrier 310 in a y-axis direction.

The lens driving device 10 may comprise an OIS-y magnet 610. The OIS-y driving part 600 may comprise an OIS-y magnet 610. The OIS-y magnet 610 may be an ‘OIS-y magnet’. The OIS-y magnet 610 may be a permanent magnet. The OIS-y magnet 520 may be disposed in the OIS moving part. The OIS-y magnet 610 may be spaced apart from the OIS-x magnet 510. The OIS-y magnet 610 may be spaced apart from the AF magnet 710. The OIS-y magnet 610 may be disposed in the OIS-y moving part 300. The OIS-y magnet 610 can be disposed on the OIS-y carrier 310. The OIS-y magnet 610 can be disposed in the lower plate of the OIS-y carrier 310. The OIS-y magnet 610 can be disposed on the lower plate of the OIS-y carrier 310. The OIS-y magnet 610 can be disposed on an upper surface of the lower plate of the OIS-y carrier 310. The OIS-y magnet 610 can be fixed to the OIS-y carrier 310. The OIS-y magnet 610 can be coupled to the OIS-y carrier 310. The OIS-y magnet 610 can be attached to the OIS-y carrier 310 with an adhesive. The OIS-y magnet 610 can be disposed within the cover 120.

The OIS-y magnet 610 can interact with the OIS-y coil 620. The OIS-y magnet 610 can electromagnetically interact with the OIS-y coil 620. The OIS-y magnet 610 can be disposed corresponding to the OIS-y coil 620. The OIS-y magnet 610 and the OIS-y coil 620 can face each other. The OIS-y magnet 610 can face the OIS-y coil 620. The OIS-y magnet 610 can be overlapped with the OIS-y coil 620 in a direction perpendicular to the optical axis. The OIS-y magnet 610 can be overlapped with the OIS-y coil 620 in an x-axis direction. The OIS-y magnet 610 can move in a y-axis direction.

The OIS-y magnet 610 may be a four-pole magnet. The OIS-y magnet 610 may comprise a four-pole magnetizing magnet. The OIS-y magnet 610 may comprise a first magnet portion comprising an N pole and an S pole, and a second magnet portion comprising an N pole and an S pole. The first magnet portion and the second magnet portion may be disposed in a horizontal direction. The first magnet portion and the second magnet portion may be spaced apart in a horizontal direction. A neutral portion may be disposed between the first magnet portion and the second magnet portion.

The lens driving device 10 may comprise an OIS-y coil 620. The OIS-y driving part 600 may comprise the OIS-y coil 620. The OIS-y coil 620 may interact with the OIS-y magnet 610. The OIS-y coil 620 may be disposed at an opposite side of the AF coil 720 with respect to an optical axis. The OIS-y coil 620 may move the OIS-y magnet 610 in a y-axis direction perpendicular to both the optical axis and the x-axis. The OIS-y coil 620 may move the OIS-y magnet 610 in a y-axis direction through interaction with the OIS-y magnet 610. The OIS-y coil 620 and the OIS-y magnet 610 may face each other. The OIS-y coil 620 can face the OIS-y magnet 610. The OIS-y coil 620 can be disposed at a position corresponding to the OIS-y magnet 610. The OIS-y coil 620 can be overlapped with the OIS-y magnet 610 in a direction perpendicular to the optical axis. The OIS-y coil 620 can be overlapped with the OIS-y magnet 610 in an x-axis direction. The OIS-y coil 620 can be disposed in the outer substrate 910. The OIS-y coil 620 can be disposed in the OIS-x carrier 210. The OIS-y coil 620 can be disposed in the OIS-x carrier 210 through the outer substrate 910. The OIS-y coil 620 can be disposed in the OIS-x moving part 200. The OIS-y coil 620 can move integrally with the OIS-x moving part 200.

In the present embodiment, the OIS-y coil 620 can move together with the OIS-x moving part 200. The OIS-y coil 620 can move in an x-axis direction together with the OIS-x moving part 200. During the OIS-x driving process, the OIS-y coil 620 can move in an x-axis direction together with the OIS-x moving part 200. The OIS-y coil 620 can be disposed on the OIS-x moving part 200. The OIS-y coil 620 can be fixed to the OIS-x moving part 200. The OIS-y coil 620 can be coupled to the OIS-x moving part 200.

The lens driving device 10 may comprise an OIS-y sensor 630. The OIS-y driving part 600 may comprise an OIS-y sensor 630. The OIS-y sensor 630 may be disposed in an outer substrate 910. The OIS-y sensor 630 may be disposed in an OIS-x carrier 210. The OIS-y sensor 630 may be disposed in an OIS-x moving part 200. The OIS-y sensor 630 may comprise a Hall sensor. The OIS-y sensor 630 may detect the OIS-y magnet 610. The OIS-y sensor 630 may detect a magnetic force of the OIS-y magnet 610. The OIS-y sensor 630 may be disposed on an upper side of the OIS-y magnet 620. The OIS-y sensor 630 may be overlapped with the OIS-y magnet 620 in an optical axis direction. In a modified embodiment, the OIS-y sensor 630 may be disposed within the OIS-y coil 620. At this time, the OIS-y sensor 630 may be overlapped with the OIS-y coil 620 in an optical axis direction. The OIS-y sensor 630 may face the OIS-y magnet 610. The OIS-y sensor 630 may be disposed at a position corresponding to the OIS-y magnet 610. The OIS-y sensor 630 may detect the movement of the OIS-y magnet 610. The amount of movement or position of the OIS-y magnet 610 detected by the OIS-y sensor 630 can be used for feedback of the shaking hand correction drive in a y-axis direction.

The lens driving device 10 may comprise an OIS-y yoke 640. The OIS-y yoke 640 may be disposed in the OIS-y magnet 610. The OIS-y yoke 640 may be disposed between the OIS-y magnet 610 and the OIS-y carrier 310. The OIS-y yoke 640 may prevent magnetic flux leakage of the OIS-y magnet 610 and enhance interaction with the OIS-y coil 620.

The lens driving device 10 may comprise an AF driving part 700. The AF driving part 700 may move the AF moving part 400 in an optical axis direction. The AF driving part 700 may move the AF carrier 410 in an optical axis direction. The AF driving part 700 may move the AF carrier 410 in an optical axis direction through electromagnetic force. The AF driving part 700 may comprise a coil and a magnet.

In the present embodiment, the AF carrier 410 can move in an optical axis direction by the interaction between the AF coil 720 and the AF magnet 710. The AF magnet 710 and the AF carrier 410 can move integrally in an optical axis direction.

The lens driving device 10 may comprise an AF magnet 710. The AF driving part 700 may comprise an AF magnet 710. The AF magnet 710 may be an ‘AF magnet’. The AF magnet 710 may be a permanent magnet. The AF magnet 710 may be disposed in the AF moving part 400. The AF magnet 710 may be disposed in the AF carrier 410. The AF magnet 710 may be disposed on an outer side surface of the AF carrier 410. The AF magnet 710 may be fixed to the AF carrier 410. The AF magnet 710 may be coupled to the AF carrier 410. The AF magnet 710 may be attached to the AF carrier 410 with an adhesive. The AF magnet 710 can be disposed within the cover 120.

The AF magnet 710 can interact with the AF coil 720. The AF magnet 710 can electromagnetically interact with the AF coil 720. The AF magnet 710 can be disposed at a position corresponding to the AF coil 720. The AF magnet 710 and the AF coil 720 can face each other. The AF magnet 710 can face the AF coil 720. The AF magnet 710 can be overlapped with the AF coil 720 in a direction perpendicular to the optical axis. The AF magnet 710 can be overlapped with the AF coil 720 in a y-axis direction.

In the present embodiment, the outer surface of the AF magnet 710 may be disposed parallel to the second side plate of the cover 120. The AF magnet 710 may be disposed parallel to the second side plate of the cover 120.

The AF magnet 710 may be a four-pole magnet. The AF magnet 710 may comprise a four-pole magnetizing magnet. The AF magnet 710 may comprise a first magnet portion comprising an N pole and an S pole, and a second magnet portion comprising an N pole and an S pole. The first magnet portion and the second magnet portion may be disposed in a vertical direction. The first magnet portion and the second magnet portion may be spaced apart in a vertical direction. The first magnet portion and the second magnet portion may be spaced apart in an optical axis direction. A neutral portion may be disposed between the first magnet portion and the second magnet portion. The lens driving device 10 may comprise an AF coil 720. The AF driving part 700 may comprise an AF coil 720. The AF coil 720 may interact with an AF magnet 710. The AF coil 720 and AF magnet 710 may face each other the. The AF coil 720 may face the AF magnet 710. The AF coil 720 may be disposed at a position corresponding to the AF magnet 710. The AF coil 720 may be overlapped with the AF magnet 710 in a direction perpendicular to the optical axis. The AF coil 720 may be disposed in an inner substrate 920. The AF coil 720 may be disposed in an OIS-y carrier 310. The AF coil 720 can be disposed on the OIS-y carrier 310 through the inner substrate 920. The AF coil 720 can move integrally with the OIS-y carrier 310. The AF coil 720 can be disposed in the OIS-y moving part 300. The AF coil 720 can move integrally with the OIS-y moving part 300.

The lens driving device 10 may comprise an AF sensor 730. The AF driving part 700 may comprise an AF sensor 730. The AF sensor 730 may be a Hall sensor. The AF sensor 730 may be disposed in the inner substrate 720. The AF sensor 730 may detect the AF magnet 710. The AF sensor 730 may detect the movement of the AF magnet 710. The movement amount or position of the AF magnet 710 detected by the AF sensor 730 may be used for feedback of auto focus driving. The AF sensor 730 may be disposed in the OIS-y moving part 300. The AF sensor 730 may be disposed in the OIS-y carrier 310. The AF sensor 730 can be disposed on the OIS-y carrier 310 through the inner substrate 720. The AF sensor 730 can move together with the OIS-y moving part 300.

The AF sensor 730 may be a driver IC. The driver IC may comprise a sensing unit. The sensing unit may comprise a Hall element (Hall IC). The driver IC may be electrically connected to the AF coil 720. The driver IC may supply current to the AF coil 720.

The AF sensor 730 may be disposed within the AF coil 720. The AF sensor 730 may be overlapped with the neutral portion of the AF magnet 710 in a direction perpendicular to the optical axis. In a modified embodiment, the AF sensor 730 may be disposed on an outside of the AF coil 720.

The lens driving device 10 may comprise an AF yoke 740. The AF yoke 740 may be disposed at a position corresponding to the AF magnet 710. The AF yoke 740 may be disposed in the AF magnet 710. The AF yoke 740 may be disposed between the AF magnet 710 and the AF carrier 410. The AF yoke 740 may be disposed on an inner surface of the AF magnet 710. The AF yoke 740 may be disposed on an outer surface of the AF carrier 410. Through this, the AF yoke 740 may minimize the leakage magnetic flux of the AF magnet 710 and increase the electromagnetic interaction force between the AF magnet 710 and the AF coil 720.

When viewed from above, the OIS-x coil 520, the OIS-x magnet 510, the AF magnet 710, and the AF coil 720 can be disposed in sequence on a virtual straight line. When viewed from above, the OIS-x coil 520, the OIS-x magnet 510, the AF magnet 710, and the AF coil 720 can be disposed in sequence. When viewed from above, the OIS-x coil 520, the OIS-x magnet 510, the AF magnet 710, and the AF coil 720 can be disposed in sequence in a y-axis direction. When viewed from above, the OIS-x coil 520, the OIS-x magnet 510, the AF magnet 710, and the AF coil 720 can be overlapped in a y-axis direction.

In the present embodiment, the cover 120 may comprise a first side plate and a second side plate being disposed opposite to each other, and a third side plate and a fourth side plate being disposed opposite to each other. An OIS-x driving part 500 may be disposed at a position corresponding to the first side plate of the cover 120, an AF driving part 700 may be disposed at a position corresponding to the third side plate of the cover 120, and an OIS-y driving part 600 may be disposed at a position corresponding to the second side plate of the cover 120.

The lens driving device 10 may comprise a guide member. The guide member may comprise a ball. The guide member may comprise a pin. The guide member may comprise a cylindrical member. The guide member may guide movement of the moving part relative to the fixed part 100 in a specific direction.

The lens driving device 10 may comprise an OIS-x guide ball 810. The OIS-x guide ball 810 may guide movement of the OIS-x moving part 200 against the fixed part 100 in an x-axis direction. The OIS-x guide ball 810 may guide movement of the OIS-x carrier 210 against the base 110 in an x-axis direction. The OIS-x guide ball 810 may be disposed between the fixed part 100 and the OIS-x moving part 200. The OIS-x guide ball 810 may be disposed between the fixed part 100 and the OIS-x moving part 200 in a y-axis direction. The OIS-x guide ball 810 may be disposed between the base 110 and the OIS-x carrier 210. The OIS-x guide ball 810 can be disposed between the base 110 and the OIS-x carrier 210 in a y-axis direction. The entire area from the lower end to the upper end of the OIS-x guide ball 810 can be overlapped with both the base 110 and the OIS-x carrier 210 in a y-axis direction. The entire area of the OIS-x guide ball 810 can be overlapped with the base 110 and the OIS-x carrier 210 in a y-axis direction. The OIS-x guide ball 810 can be disposed between the outer side surface of the base 110 and the inner side surface of the OIS-x carrier 210. When viewed from the inner side of the OIS-x carrier 210, the OIS-x guide ball 810 can be overlapped with the OIS-x magnet 510 in a horizontal direction.

The OIS-x guide ball 810 may be disposed in a groove 112 of the base 110. The OIS-x guide ball 810 may be disposed in a groove 211 of the OIS-x carrier 210. The OIS-x guide ball 810 may comprise a first ball being in contact with the base 110 and the OIS-x carrier 210 at four points, and a second ball being in contact with the base 110 and the OIS-x carrier 210 at three points. The OIS-x guide ball 810 may be spherical. The OIS-x guide ball 810 may be formed of metal. Grease may be applied to a surface of the OIS-x guide ball 810.

The OIS-x guide ball 810 may comprise a plurality of balls. The OIS-x guide ball 810 may comprise four balls. Two OIS-x guide balls 810 may be disposed on one side of the OIS-x magnet 510, and the remaining two OIS-x guide balls 810 may be disposed on the other side of the OIS-x magnet 510.

The lens driving device 10 may comprise an OIS-y guide ball 820. The OIS-y guide ball 820 may guide the movement of the OIS-y carrier 310 against the OIS-x carrier 210 in a y-axis direction. The OIS-y guide ball 820 may be disposed between the OIS-x moving part 200 and the OIS-y moving part 300. The OIS-y guide ball 820 may be disposed between the OIS-x moving part 200 and the OIS-y moving part 300 in an x-axis direction. The OIS-y guide ball 820 may be disposed between the OIS-x carrier 210 and the OIS-y carrier 310. The OIS-y guide ball 820 can be disposed between the OIS-x carrier 210 and the OIS-y carrier 310 in an x-axis direction. The entire area from the lower end to the upper end of the OIS-y guide ball 820 can be overlapped with both the OIS-x carrier 210 and the OIS-y carrier 310 in an x-axis direction. The OIS-y guide ball 820 can be disposed between an inner side surface of the OIS-x carrier 210 and the outer side surface of the OIS-y carrier 310. When viewed from the outer side of the OIS-y carrier 310, the OIS-y guide ball 820 can be overlapped with the OIS-y magnet 610 in a horizontal direction. Here, the horizontal direction can be any direction perpendicular to the optical axis.

A part of the OIS-y guide ball 820 may be overlapped with the OIS-x carrier 210 in a y-axis direction. Another part of the OIS-y guide ball 820 may be overlapped with the OIS-y carrier 310 in a y-axis direction.

The OIS-y guide ball 820 may be disposed in the groove 212 of the OIS-x carrier 210. The OIS-y guide ball 820 may be disposed in the groove 311 of the OIS-y carrier 310. The OIS-y guide ball 820 may comprise a first ball being in contact with the OIS-x carrier 210 and the OIS-y carrier 310 at four points, and a second ball being in contact with the OIS-x carrier 210 and the OIS-y carrier 310 at three points. The OIS-y guide ball 820 may be spherical. The OIS-y guide ball 820 may be formed of metal. Grease may be applied to the surface of the OIS-y guide ball 820.

The OIS-y guide ball 820 may comprise a plurality of balls. The OIS-y guide ball 820 may comprise four balls. Two OIS-y guide balls 820 may be disposed on one side of the OIS-y magnet 610, and the remaining two OIS-y guide balls 820 may be disposed on the other side of the OIS-y magnet 610.

The lens driving device 10 may comprise an AF guide ball 830. The AF guide ball 830 may guide movement of the AF carrier 410 against the OIS-y carrier 310 in an optical axis direction. The AF guide ball 830 may be disposed between the OIS-y moving part 300 and the AF moving part 400. The AF guide ball 830 may be disposed between the OIS-y moving part 300 and the AF moving part 400 in a y-axis direction. The AF guide ball 830 may be disposed between the OIS-y carrier 310 and the AF carrier 410. The AF guide ball 830 may be disposed between the OIS-y carrier 310 and the AF carrier 410 in a y-direction. The AF guide ball 830 may be disposed in the groove 312 of the OIS-y carrier 310. The AF guide ball 830 may be disposed in the groove 411 of the AF carrier 410. The AF guide ball 830 may be spherical. The AF guide ball 830 may be formed of metal. Grease may be applied to the surface of the AF guide ball 830.

The AF guide ball 830 may comprise a plurality of balls. The AF guide ball 830 may comprise four balls. Two AF guide balls 830 may be disposed at one side of the AF magnet 710 and the remaining two AF guide balls 830 may be disposed at the other side of the AF magnet 710. The lens driving device 10 may comprise a guide ball pressurizing member. The guide ball pressurizing member may pressurize the guide balls 810, 820, and 830. The guide ball pressurizing member may maintain the state in which the guide balls 810, 820, and 830 are in contact between two other members.

The lens driving device 10 may comprise an OIS-x ball pressurizing yoke 860. The OIS-x ball pressurizing yoke 860 may pressurize the OIS-x guide ball 810. The OIS-x ball pressurizing yoke 860 may allow the OIS-x guide ball 810 to remain in contact with the fixed part 100 and the OIS-x moving part 200. The OIS-x ball pressurizing yoke 860 may allow the OIS-x guide ball 820 to remain in contact with the base 110 and the OIS-x carrier 210. The OIS-x ball pressurizing yoke 860 may be disposed to exert an attractive force on the OIS-x magnet 510. The OIS-x ball pressurizing yoke 860 may be disposed on an outer surface of the outer substrate 910. The OIS-x ball pressurizing yoke 860 can be disposed on the OIS-x moving part 200.

The lens driving device 10 may comprise an OIS-y ball pressurizing yoke 870. The OIS-y ball pressurizing yoke 870 may pressurize the OIS-y guide ball 820. The OIS-y ball pressurizing yoke 870 may allow the OIS-y guide ball 820 to be maintained in contact with the OIS-x moving part 200 and the OIS-y moving part 300. The OIS-y ball pressurizing yoke 870 may allow the OIS-x guide ball 820 to be maintained in contact with the OIS-x carrier 210 and the OIS-y carrier 310. The OIS-y ball pressurizing yoke 870 may be disposed to exert an attractive force on the OIS-y magnet 610. The OIS-y ball pressurizing yoke 870 can be disposed on an outer surface of the outer substrate 910. The OIS-y ball pressurizing yoke 870 can be disposed in the OIS-x moving part 200.

The lens driving device 10 may comprise an AF ball pressurizing yoke 880. The AF ball pressurizing yoke 880 may pressurize the AF guide ball 830. The AF ball pressurizing yoke 880 may allow the AF guide ball 830 to be maintained in contact with the OIS-y moving part 300 and the AF moving part 400. The AF ball pressurizing yoke 880 may allow the AF guide ball 830 to be maintained in contact with the OIS-y carrier 310 and the AF carrier 410. The AF ball pressurizing yoke 880 may be disposed to exert attractive force on the AF magnet 710. The AF ball pressurizing yoke 880 may be disposed on an outer surface of the inner substrate 920. The AF ball pressurizing yoke 880 may be disposed in the OIS-y moving part 300.

The lens driving device 10 may comprise substrates 910 and 920. The substrates 910 and 920 may comprise a flexible printed circuit board FPCB. The substrates 910 and 920 may be electrically connected to the coils 520, 620, and 720. The substrates 910 and 920 may be electrically connected to the sensors 530, 630, and 730.

The lens driving device 10 may comprise an outer substrate 910. The outer substrate 910 may be disposed in the base 110 and the OIS-x carrier 210. The outer substrate 910 may connect the base 110 and the OIS-x carrier 210. The outer substrate 910 may elastically connect the base 110 and the OIS-x carrier 210. The outer substrate 910 may movably support the OIS-x carrier 210 against the base 110. The outer substrate 910 may be electrically connected to the OIS-x coil 520. The outer substrate 910 may be electrically connected to the OIS-y coil 620. The outer substrate 910 may be electrically connected to the OIS-x sensor 530. The outer substrate 910 may be electrically connected to the OIS-y sensor 630. The outer substrate 910 may comprise a flexible substrate. The outer substrate 910 may comprise a flexible printed circuit board (FPCB). The outer substrate 910 may comprise an elastic portion. The outer substrate 910 may comprise an elastic member.

The outer substrate 910 may comprise an outer portion 911. The outer portion 911 may be disposed on the fixed part 100. The outer portion 911 may be disposed in the base 110. The outer portion 911 may be disposed on a side surface of the base 110. The outer portion 911 may be disposed on a lower plate 111 of the base 110. The outer portion 911 may be disposed on two side surfaces of the base 110. The outer portion 911 may comprise two terminal portions. The two terminal portions may be disposed opposite to each other with respect to an optical axis. The terminal portion may comprise a terminal 862-1.

The outer substrate 910 may comprise a terminal 911a. The outer portion 911 of the outer substrate 910 may comprise a terminal 911a. The terminal 911a may be disposed at a lower end of the base 110. The terminal 911a may be coupled to a printed circuit board 50. The terminal 911a may be coupled to a terminal of the printed circuit board 50 via a solder. The terminal 911a may be coupled to a terminal of the printed circuit board 50 via a conductive member. The terminal 911a may be connected to a terminal of the printed circuit board 50. The terminal 911a may be electrically connected to a terminal of the printed circuit board 50.

The outer substrate 910 may comprise an inner portion 912. The inner portion 912 may be disposed in an OIS-x moving part 200. The inner portion 912 may be disposed in an OIS-x carrier 210. A coil may be disposed in the inner portion 912. An OIS-x coil 520 may be disposed in the inner portion 912. An OIS-y coil 620 may be disposed in the inner portion 912. A sensor may be disposed in the inner portion 912. An OIS-x sensor 530 may be disposed in the inner portion 912. An OIS-y sensor 630 may be disposed in the inner portion 912. The inner portion 912 may comprise a first region where an OIS-x coil 520 is disposed, a second region where the OIS-y coil 620 is disposed, a third region where the OIS-x sensor 530 is disposed, and a fourth region where the OIS-y sensor 630 is disposed.

The outer substrate 910 may comprise a connecting portion 913. The connecting portion 913 may be an ‘extension portion’. The connecting portion 913 may be a ‘leg portion’. The connecting portion 913 may connect the outer portion 911 and the inner portion 912. The connecting portion 913 may be extended from the outer portion 911. At least a portion of the connecting portion 913 may move together with the OIS-x carrier 210. At least a portion of the connecting portion 913 may be disposed parallel to an optical axis direction. At least a portion of the connecting portion 913 of the outer substrate 910 may be movably formed in an x-axis direction. The connecting portion 913 may comprise a flexible substrate. The connecting portion 913 may be flexible. The connecting portion 913 may comprise a flexible printed circuit board (FPCB). The connecting portion 913 may comprise an elastic portion. The connecting portion 913 may comprise an elastic member.

The lens driving device 10 may comprise an inner substrate 920. The inner substrate 920 may be electrically connected to the AF coil 720. The inner substrate 920 may be electrically connected to the AF sensor 730. The inner substrate 920 may be disposed in the fixed part 100. The inner substrate 920 may be disposed in the OIS-y moving part 300. The inner substrate 920 may connect the base 110 and the OIS-y carrier 310. The inner substrate 920 may elastically connect the base 110 and the OIS-y carrier 310. The inner substrate 920 may movably support the OIS-y carrier 310 against the base 110. The inner substrate 920 may comprise a flexible substrate. The inner substrate 920 may comprise a flexible printed circuit board (FPCB). The inner substrate 920 may comprise an elastic portion. The inner substrate 920 may comprise an elastic member.

The inner substrate 920 may comprise an outer portion 921. The outer portion 921 may be disposed in the fixed part 100. The outer portion 921 may be disposed in the base 110. The outer portion 921 may be disposed on a side surface of the base 110. The outer portion 921 may be disposed In a lower plate 111 of the base 110.

The inner substrate 920 may comprise a terminal 921a. The outer portion 921 may comprise a terminal 921a. The outer portion 921 of the inner substrate 920 may comprise a terminal 921a. The terminal 921a may be disposed at a lower end of the base 110. The terminal 921a may be coupled to a printed circuit board 50. The terminal 921a may be coupled to a terminal of the printed circuit board 50 via a solder. The terminal 921a may be coupled to a terminal of the printed circuit board 50 via a conductive member. The terminal 921a may be connected to a terminal of the printed circuit board 50. The terminal 921a may be electrically connected to a terminal of the printed circuit board 50.

The inner substrate 920 may comprise an inner portion 922. The inner portion 922 may be disposed in an OIS-y moving part 300. The inner portion 922 may be disposed in an OIS-y carrier 310. A coil may be disposed in the inner portion 922. An AF coil 720 may be disposed in the inner portion 922. A sensor may be disposed in the inner portion 912. An AF sensor 730 may be disposed in the inner portion 922. The inner portion 922 may comprise a first region in which the AF coil 720 is disposed and a second region in which the AF sensor 730 is disposed.

The inner substrate 920 may comprise a connecting portion 923. The connecting portion 923 may be an ‘extension portion’. The connecting portion 923 may be a ‘leg portion’. The connecting portion 923 may connect the outer portion 921 and the inner portion 922. The connecting portion 923 may be extended from the outer portion 921. At least a portion of the connecting portion 923 may move together with the OIS-y carrier 310. At least a portion of the connecting portion 923 may be disposed parallel to an optical axis direction. At least a portion of the connecting portion 923 of the inner substrate 920 may be movably formed in an x-axis direction. At least a portion of the connecting portion 923 of the inner substrate 920 may be movably formed in a y-axis direction. The connecting portion 923 may comprise a flexible substrate. The connecting portion 923 may have flexibility. The connecting portion 923 may comprise a flexible printed circuit board (FPCB). The connecting portion 923 may comprise an elastic portion. The connecting portion 923 may comprise an elastic member. At least a portion of the connecting portion 923 of the inner substrate 920 may be movably formed in an x-axis direction and a y-axis direction.

The connecting portion 923 may comprise an x-axis moving connecting portion 923-1. The x-axis moving connecting portion 923-1 may movably support the OIS-y moving part 300 in an x-axis direction. The x-axis moving connecting portion 923-1 may movably support the OIS-y carrier 310 in an x-axis direction. The x-axis moving connecting portion 923-1 may be disposed parallel to a y-axis. The x-axis moving connecting portion 923-1 may be disposed parallel to an optical axis. The x-axis moving connecting portion 923-1 may comprise first to third portions overlapping in the optical axis direction. The x-axis moving connecting portion 923-1 may comprise a bent shape.

The connecting portion 923 may comprise a y-axis moving connecting portion 923-2. The y-axis moving connecting portion 923-2 may movably support the OIS-y moving part 300 in a y-axis direction. The y-axis moving connecting portion 923-2 may movably support the OIS-y carrier 310 in a y-axis direction. The y-axis moving connecting portion 923-2 may be disposed parallel to an x-axis. The y-axis moving connecting portion 923-2 may be disposed parallel to an optical axis. The y-axis moving connecting portion 923-2 may be overlapped with the inner portion 922 in an optical axis direction. The y-axis moving connecting portion 923-2 may comprise a bent shape.

Hereinafter, one of the “x-axis flow connecting portion 923-1” and the “y-axis flow connecting portion 923-2” may be referred to as a “first connecting portion” and the other may be referred to as a “second connecting portion”.

Hereinafter, the configuration of a lens driving device according to a modified embodiment is described with reference to the drawings.

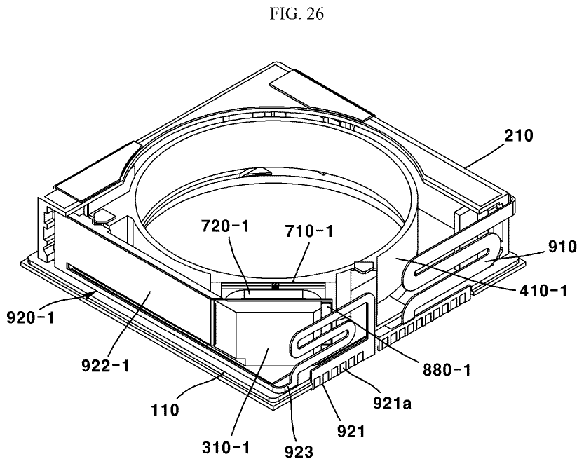

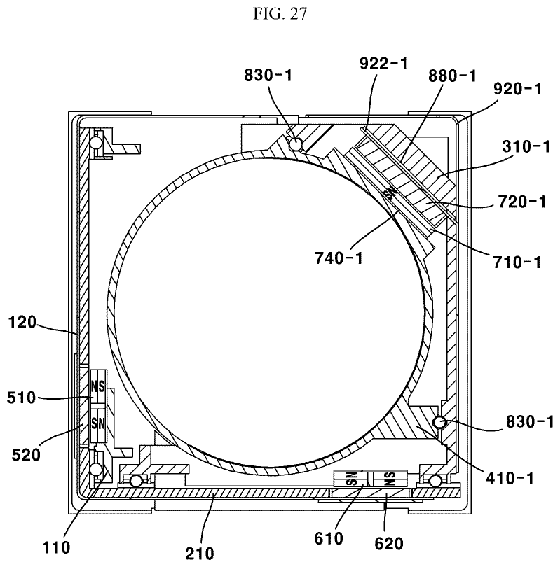

FIG. 26 is a perspective view of the lens driving device according to a modified example with the cover omitted, FIG. 27 is a cross-sectional view of FIG. 26 cut in a direction perpendicular to the optical axis and viewed from above.

In a modified embodiment, the OIS-y carrier 310-1 may comprise a side wall on which the AF coil 720-1 is disposed.

The cover 120 may comprise first and second side plates being disposed opposite each other, and third and fourth side plates being disposed opposite each other. As illustrated in FIG. 27, when viewed from above, the outer surface of the AF magnet 710-1 may be inclinedly disposed between the second and fourth side plates of the cover 120. The AF magnet 710-1 may be inclinedly disposed between the side plates of the cover 120. The AF coil 720-1 may be inclinedly disposed between the side plates of the cover 120. The AF yoke 740-1 may be inclinedly disposed between the side plates of the cover 120. The AF ball pressurization yoke 880-1 may be inclinedly disposed between the side plates of the cover 120.

The position of the AF guide ball 830-1 may be changed compared to the present embodiment. One set of AF guide balls 830-1 may be moved and disposed toward the center compared to the present embodiment. The structure of the AF carrier 830-1 on which the AF guide ball 830-1 is disposed may also be changed.

The inner substrate 920-1 may comprise a first portion 922-1 being disposed on a side wall of the OIS-y carrier 310-1. The AF coil 720-1 may be disposed in the first portion 922-1 of the inner substrate 920-1. The AF ball pressurizing yoke 880-1 may be disposed in the first portion 922-1 of the inner substrate 920-1.

In a modified embodiment, the AF magnet 710-1 and the AF coil 720-1 can be inclinedly disposed in the corner area. In a modified embodiment, the AF magnet 710-1 and the AF coil 720-1 can be disposed not parallel to the side plate 122 of the cover 120, thereby securing more space within the cover 120. Through this, a greater driving force can be obtained in a modified embodiment compared to the present embodiment.

Hereinafter, the auto focus (AF) driving of the lens driving device according to the present embodiment is described with reference to the drawings.

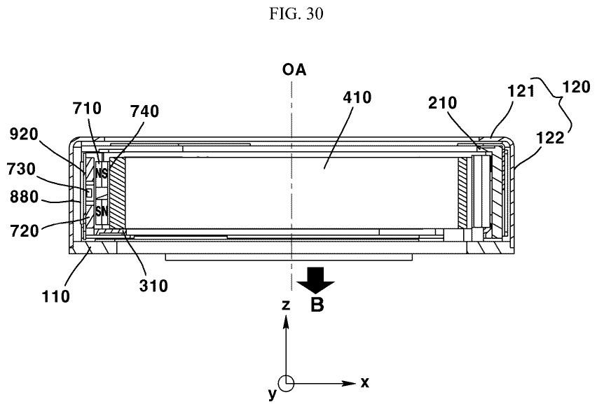

FIGS. 28 to 30 are diagrams for explaining the auto focus driving of a lens driving device according to the present embodiment. FIG. 28 is a cross-sectional view illustrating the appearance of a moving part in an initial state where no current is applied to the AF coil. FIG. 29 is a cross-sectional view illustrating the appearance where a moving part moves upward in an optical axis direction when a forward current is applied to an AF coil. FIG. 30 is a cross-sectional view illustrating the appearance where a moving part moves downward in an optical axis direction when a reverse current is applied to an AF coil.

As illustrated in FIG. 28, the moving part may be disposed at a position spaced apart from both the top plate 121 of the cover 120 and the base 110 in the initial position where no current is applied to the AF coil 720. At this time, the moving part may be an AF moving part 400.

When a positive current is applied to the AF coil 720, the AF magnet 710 can move upward in an optical axis direction due to the electromagnetic interaction between the AF coil 720 and the AF magnet 710 (see A of FIG. 29). At this time, the AF carrier 410 can move upward in an optical axis direction together with the AF magnet 710. Furthermore, the lens can move upward in an optical axis direction together with the AF carrier 410. Accordingly, the distance between the lens and the image sensor can be changed, and the focus of the image being formed on the image sensor through the lens can be adjusted.

When a reverse current is applied to the AF coil 720, the AF magnet 710 can move downward in an optical axis direction due to the electromagnetic interaction between the AF coil 720 and the AF magnet 710 (see B of FIG. 30). At this time, the AF carrier 410 can move downward in an optical axis direction together with the AF magnet 710. Furthermore, the lens can move downward in an optical axis direction together with the AF carrier 410. Accordingly, the distance between the lens and the image sensor can be changed, and the focus of the image being formed on the image sensor through the lens can be adjusted.

Meanwhile, during the movement process of the AF magnet 710, the AF sensor 730 can detect the amount of movement or position of the lens in an optical axis direction by detecting the strength of the magnetic field of the AF magnet 710. The amount of movement or position of the lens in an optical axis direction detected by the AF sensor 730 can be used for auto focus feedback control.

Hereinafter, the optical image stabilization (OIS) driving of a lens driving device according to the present embodiment will be described with reference to the drawings.

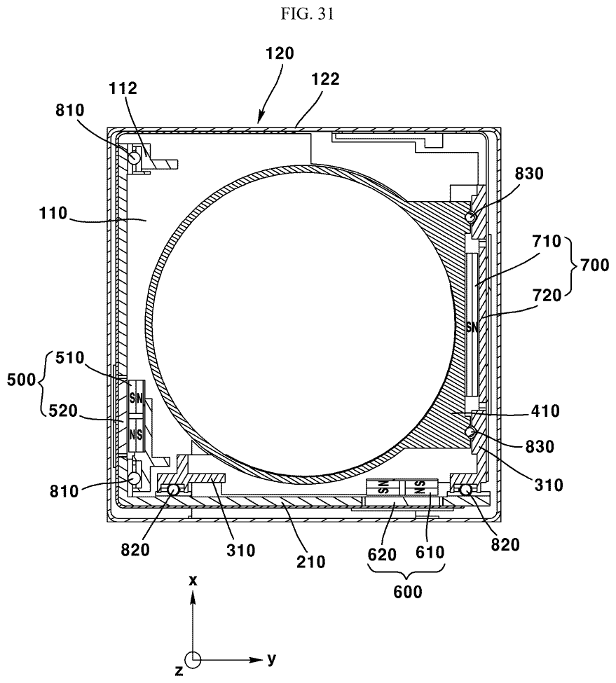

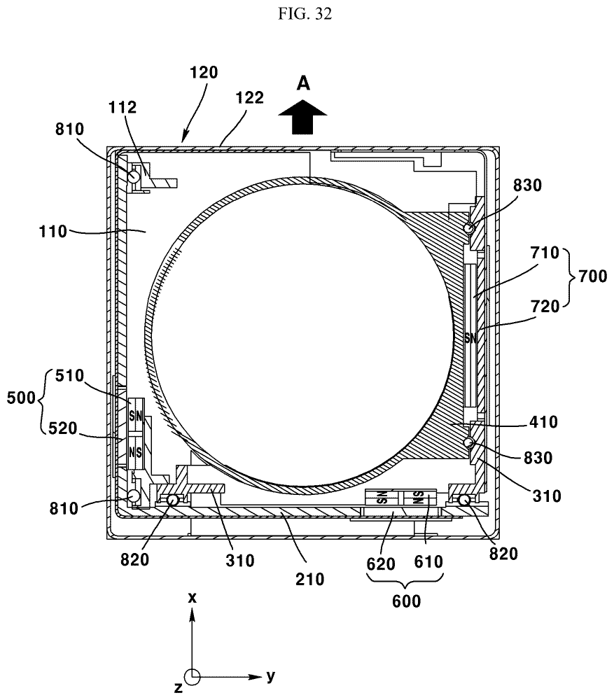

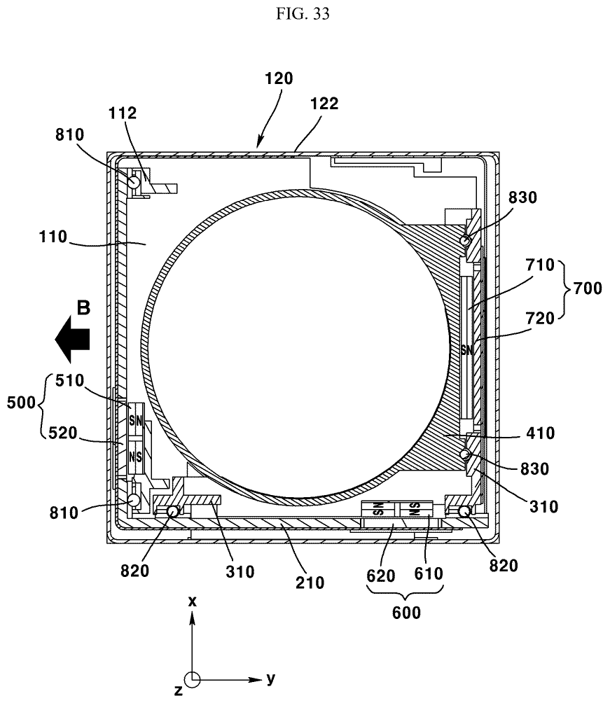

FIGS. 31 to 33 are diagrams for explaining the shaking hand correction driving of a lens driving device according to the present embodiment. FIG. 31 is a cross-sectional view illustrating the appearance of an OIS moving part in an initial state in which no current is applied to an OIS-x coil and an OIS-y coil; FIG. 32 is a cross-sectional view illustrating the appearance in which an OIS moving part moves in an x-axis direction perpendicular to the optical axis when current is applied to the OIS-x coil; and FIG. 33 is a cross-sectional view illustrating the appearance in which the OIS-y moving part moves in a y-axis direction perpendicular to both the optical axis and the x-axis when current is applied to an OIS-y coil.

As illustrated in FIG. 31, the moving part may be disposed at an initial position where no current is applied to the OIS-x coil 520 and the OIS-y coil 620. At this time, the moving part may be an OIS moving part. The moving part may be an OIS-x moving part 200 and an OIS-y moving part 300. Furthermore, the moving part may comprise an OIS-x moving part 200, an OIS-y moving part 300, and an AF moving part 400.

When a current is applied to the OIS-x coil 520, the OIS-x magnet 510 may move in an x-axis direction perpendicular to the optical axis by an electromagnetic interaction between the OIS-x coil 520 and the OIS-x magnet 510 (see A of FIG. 32). At this time, the OIS-x carrier 210 may move in an x-axis direction together with the OIS-x coil 520. Furthermore, the OIS-y carrier 310, AF carrier 410, and the lens may move in an x-axis direction together with the OIS-x carrier 210. In more detail, when a forward current is applied to the OIS-x coil 520, the OIS-x coil 520, the OIS-x carrier 210, the OIS-y carrier 310, AF carrier 410, and the lens may move in one direction on the x-axis. Furthermore, when a reverse current is applied to the OIS-x coil 520, OIS-x coil 520, OIS-x carrier 210, OIS-y carrier 310, AF carrier 410, and the lens may move in the other direction on an x-axis.

When a current is applied to the OIS-y coil 620, the OIS-y magnet 610 may move in a y-axis direction perpendicular to the optical axis by an electromagnetic interaction between the OIS-y coil 620 and the OIS-y magnet 610 (see B of FIG. 33). At this time, the OIS-y carrier 310 may move in a y-axis direction together with the OIS-y magnet 610. Furthermore, the lens may move in a y-axis direction together with the OIS-y carrier 310. More specifically, when a forward current is applied to the OIS-y coil 620, the OIS-y magnet 610, the OIS-y carrier 310, the AF carrier 410, and the lens may move in one direction on a y-axis. In addition, when a reverse current is applied to the OIS-y coil 620, the OIS-y magnet 610, the OIS-y carrier 310, the AF carrier 410, and the lens may move in the other direction on the y-axis.

Meanwhile, the OIS-x sensor 530 may detect the strength of the magnetic field of the OIS-x magnet 510 and detect the relative movement amount or position of the OIS-x coil 520. The movement amount or position detected by the OIS-x sensor 530 may be used for shaking hand correction feedback control in an x-axis direction. The OIS-y sensor 630 may detect the strength of the magnetic field of the OIS-y magnet 610 and detect the movement amount or position of the OIS-y magnet 610. The movement amount or position detected by the OIS-y sensor 630 may be used for shaking hand correction feedback control in a y-axis direction.

Hereinafter, a camera device according to the present embodiment is described with reference to the drawings.

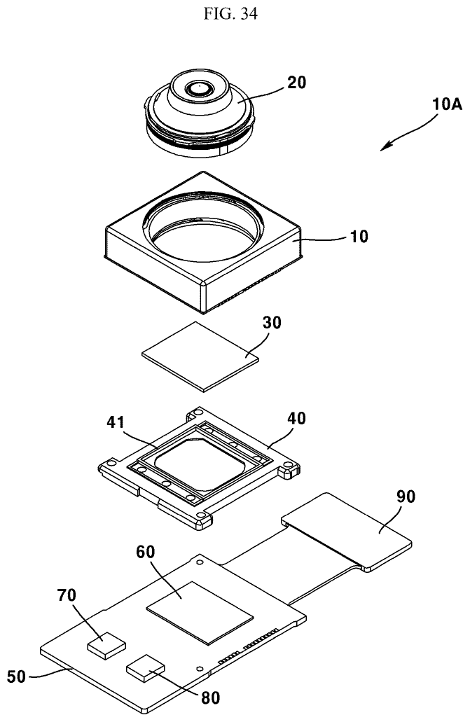

FIG. 34 is an exploded perspective view of a camera device according to the present embodiment.

The camera device 10A may comprise a camera module.

The camera device 10A may comprise a lens module 20. The lens module 20 may comprise at least one lens. The lens may be disposed at a position corresponding to the image sensor 60. The lens module 20 may comprise a lens and a barrel. The lens module 20 may be coupled to an AF carrier 410 of the lens driving device 10. The lens module 20 may be coupled to the AF carrier 410 by screw-coupling and/or adhesive. The lens module 20 may be moved integrally with the AF carrier 410.

The camera device 10A may comprise a filter 30. The filter 30 may block light of a specific frequency band from passing through the lens module 20 from being incident on the image sensor 60. The filter 30 may be disposed parallel to an x-y plane. The filter 30 may be disposed between the lens module 20 and the image sensor 60. The filter 30 may be disposed in the sensor base 40. In a modified embodiment, the filter 30 may be disposed in the base 110. The filter 30 may comprise an infrared filter. The infrared filter may block light in an infrared region from being incident on the image sensor 60.

The camera device 10A may comprise a sensor base 40. The sensor base 40 may be disposed between the lens driving device 10 and the printed circuit board 50. The sensor base 40 may comprise a protruding portion 41 in which a filter 30 is disposed. An opening may be formed in a portion of the sensor base 40 in which the filter 30 is disposed so that light passing through the filter 30 may be incident on the image sensor 60. An adhesive member may couple or attach the base 110 of the lens driving device 10 to the sensor base 40. The adhesive member may additionally serve to prevent foreign substances from entering the interior of the lens driving device 10. The adhesive member may comprise at least one among an epoxy, a thermosetting adhesive, and an ultraviolet-curable adhesive.

The camera device 10A may comprise a printed circuit board (PCB) 50. The printed circuit board 50 may be a substrate or a circuit board. A lens driving device 10 may be disposed in the printed circuit board 50. A sensor base 40 may be disposed between the printed circuit board 50 and the lens driving device 10. The printed circuit board 50 may be electrically connected to the lens driving device 10. An image sensor 60 may be disposed in the printed circuit board 50. Various circuits, elements, control units, and the like may be provided in the printed circuit board 50 to convert an image being formed on the image sensor 60 into an electrical signal and transmit it to an external device.

The camera device 10A may comprise an image sensor 60. The image sensor 60 may be configured such that light passing through a lens and a filter 30 is incident to form an image. The image sensor 60 may be mounted on a printed circuit board 50. The image sensor 60 may be electrically connected to the printed circuit board 50. For example, the image sensor 60 may be coupled to the printed circuit board 50 by surface mounting technology (SMT). As another example, the image sensor 60 may be coupled to the printed circuit board 50 by flip chip technology. The image sensor 60 may be disposed such that its optical axis is aligned with that of the lens. That is, the optical axis of the image sensor 60 and the optical axis of the lens may be aligned. The image sensor 60 can convert light being irradiated to the effective image area of the image sensor 60 into an electrical signal. The image sensor 60 can be any one among a charge coupled device (CCD), a metal oxide semi-conductor (MOS), a CPD, and a CID.

The camera device 10A may comprise a motion sensor 70. The motion sensor 70 may be mounted on a printed circuit board 50. The motion sensor 70 may be electrically connected to a control unit 80 through a circuit pattern provided in the printed circuit board 50. The motion sensor 70 may output rotational velocity information due to the movement of the camera device 10A. The motion sensor 70 may comprise a two-axis or three-axis gyro sensor or an angular velocity sensor.

The camera device 10A may comprise a control unit 80. The control unit 80 may be disposed in a printed circuit board 50. The control unit 80 may be electrically connected to a coil 330 of a lens driving device 10. The control unit 80 may individually control the direction, intensity, and amplitude of current supplied to the coil 330. The control unit 80 may control the lens driving device 10 to perform an auto-focus function and/or a shaking hand correction function. Furthermore, the control unit 80 may perform auto-focus feedback control and/or shaking hand correction feedback control for the lens driving device 10.

The camera device 10A may comprise a connector 90. The connector 90 may be electrically connected to a printed circuit board 50. The connector 90 may comprise a port for being electrically connected to an external device.

Hereinafter, an optical device according to the present embodiment is described with reference to drawings.

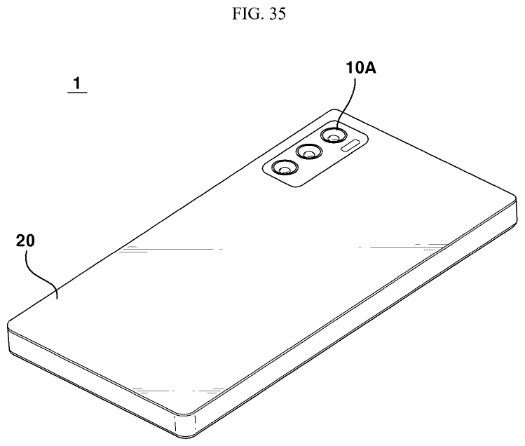

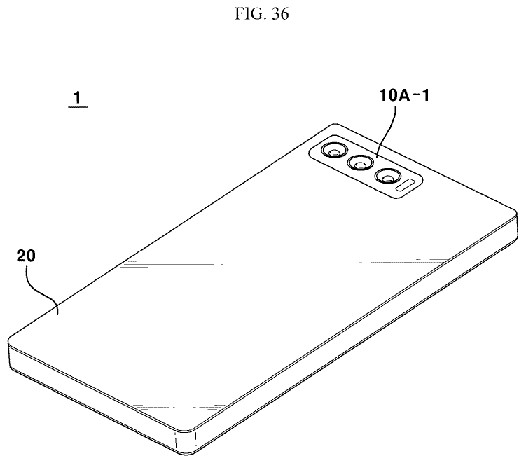

FIG. 35 is a perspective view of an optical device according to the present embodiment; and FIG. 36 is a perspective view of an optical device according to a modified embodiment.

The optical device 1 may comprise any one or more among a mobile phone, a cellular phone, a portable terminal, a mobile terminal, a smart phone, a smart pad, a portable smart device, a digital camera, a laptop computer, a digital broadcasting terminal, a personal digital assistant (PDA), a portable multimedia player (PMP), and a navigation device. The optical device 1 may comprise any device for photographing images or pictures.

The optical device 1 may comprise a main body 20. The optical device 1 may comprise a camera device 10A. The camera device 10A may be disposed in the main body 20. The camera device 10A may photograph a subject. The optical device 1 may comprise a display. The display may be disposed in the main body 20. The display may output one or more of an image and a video photographed by the camera device 10A. The display may be disposed on a first surface of the main body 20. The camera device 10A may be disposed on one or more of the first surface of the main body 20 and the second surface opposite to the first surface. As illustrated in FIG. 35, the camera device 10A may have a triple camera disposed in a vertical direction. As illustrated in FIG. 36, the camera device 10A-1 may have a triple camera disposed in a horizontal direction.

Although the present embodiment of the present invention has been described with reference to the attached drawings, those skilled in the art will understand that the present invention can be implemented in other specific forms without changing the technical idea or essential characteristics thereof. Therefore, it should be understood that the embodiments described above are exemplary in all respects and not restrictive.

1. A lens driving device comprising:
a fixed part;
a first moving part disposed on the fixed part;
a second moving part disposed in the first moving part;
a third moving part disposed in the second moving part;
a first driving part configured to move the first moving part in a first direction perpendicular to an optical axis direction;
a second driving part configured to move the second moving part in a second direction perpendicular to the optical axis direction and the first direction; and
a third driving part configured to move the third moving part in the optical axis direction,
wherein the first driving part comprises a first magnet disposed on the fixed part and a first coil disposed on the first moving part, and
wherein the second driving part comprises a second magnet disposed on the second moving part and a second coil disposed on the first moving part.

2. The lens driving device of claim 1, wherein the third driving part comprises a third magnet disposed on the third moving part and a third coil disposed on the second moving part.

3. The lens driving device of claim 1, comprising a first ball disposed between the fixed part and the first moving part in the second direction

4. The lens driving device of claim 1, comprising a second ball disposed between the first moving part and the second moving part in the first direction.

5. The lens driving device of claim 1, comprising a third ball disposed between the second moving part and the third moving part in the second direction.

6. The lens driving device of claim 3, wherein the fixed part comprises a lower plate and a protruding portion protruding from the lower plate,
wherein the protruding portion of the fixed part is disposed in the first moving part, and
wherein the first ball is disposed on the protruding portion of the fixed part.

7. The lens driving device of claim 1, comprising a first substrate comprising an outer portion disposed on the fixed part, an inner portion disposed on the first moving part, and a connecting portion connecting the outer portion and the inner portion,
wherein at least a portion of the connecting portion of the first substrate is movably formed in the first direction.

8. The lens driving device of claim 1, comprising a second substrate comprising an outer portion disposed on the fixed part, an inner portion disposed on the second moving part, and a connecting portion connecting the outer portion and the inner portion,
wherein at least a portion of the connecting portion of the second substrate is movably formed in the first direction and the second direction.

9. The lens driving device of claim 1, comprising a first yoke disposed on the first moving part and having an attractive force with the first magnet.

10. A lens driving device comprising:
a fixed part;
a first moving part disposed on the fixed part;
a second moving part disposed in the first moving part;
a third moving part disposed in the second moving part;
a first driving part configured to move the first moving part in a first direction perpendicular to an optical axis direction;
a second driving part configured to move the second moving part in a second direction perpendicular to the optical axis direction and the first direction; and
a third driving part configured to move the third moving part in the optical axis direction,
wherein the first moving part comprises a first portion disposed outside of the fixed part, and
wherein a ball is disposed between the first portion of the first moving part and the fixed part.

11. The lens driving device of claim 1, comprising a second yoke disposed on the first moving part and having an attractive force with the second magnet.

12. The lens driving device of claim 2, comprising a third yoke disposed on the second moving part and having an attractive force with the third magnet.

13. The lens driving device of claim 2, wherein the fixed part comprises a base and a cover disposed on the base,
wherein the cover comprises a first side plate and a second side plate disposed opposite to each other, and a third side plate and a fourth side plate disposed opposite to each other, and
wherein an outer surface of the third magnet is disposed parallel to the second side plate.

14. The lens driving device of claim 2, wherein the fixed part comprises a base and a cover disposed on the base,
wherein the cover comprises a first side plate and a second side plate disposed opposite to each other, and a third side plate and a fourth side plate disposed opposite to each other, and
wherein when viewed from above, an outer surface of the third magnet is inclinedly disposed between the second side plate and the fourth side plate.

15. A camera device comprising:
a printed circuit board;
an image sensor disposed on the printed circuit board;
the lens driving device of claim 1 disposed on the printed circuit board; and
a lens coupled with the lens driving device.

16. An optical device comprising:
a main body;
the camera device of claim 15 disposed on the main body; and
a display disposed on the main body and configured to output at least any one or more of an image and a video photographed by the camera device.

17. A lens driving device comprising:
a base;
an Optical Image Stabilization (OIS)-x carrier disposed on the base;
an OIS-y carrier disposed in the OIS-x carrier;
an Auto Focus (AF) carrier disposed in the OIS-y carrier;
an OIS-x magnet and an OIS-x coil configured to move the OIS-x carrier in a direction of an X-axis perpendicular to an optical axis;
an OIS-y magnet and an OIS-y coil configured to move the OIS-y carrier in a direction of a Y-axis perpendicular to each of the optical axis and the X-axis; and
an AF magnet and an AF coil configured to move the AF carrier in a direction of the optical axis,
wherein the OIS-x coil is disposed on the OIS-x carrier, and
wherein the OIS-y coil is disposed on the OIS-x carrier.

18. The lens driving device of claim 17, wherein the OIS-x magnet is disposed on the base, and
wherein the OIS-y magnet is disposed on the OIS-y carrier.

19. The lens driving device of claim 17, wherein the AF magnet is disposed on the AF carrier, and
wherein the AF coil is disposed on the OIS-y carrier.

20. The lens driving device of claim 17, comprising an OIS-x guide ball disposed between the base and the OIS-x carrier in the direction of the Y-axis.
